(19) United States
(12) Patent Application Publication
(10) Pub. No.: US 2007/0161538 A1
(43) Pub. Date: Jul. 12, 2007

(54) Method of washing

(75) Inventors: Yuki Yanagisawa, Wakayama (JP); Katsuhiko Kasai, Wakayama (JP); Yoshinobu Imaizumi, Wakayama (JP); Hiroaki Warita, Wakayama (JP); Kazuo Oki, Wakayama (JP); Osamu Takiguchi, Wakayama (JP); Takuya Masuda, Wakayama (JP); Shu Yamaguchi, Wakayama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kao Corporation, Chuo-ku (JP)

(21) Appl. No.: 10/589,131

(22) PCT Filed: Feb. 10, 2005
(86) PCT No.: PCT/JP05/01999

§ 371 Date: Aug. 11, 2006

(30) Foreign Application Priority Data
Feb. 13, 2004 (JP) 2004-037533
May 19, 2004 (JP) 2004-149462

(51) Int. Cl. C11D 3/37

(52) U.S. Cl. 510/475

(57) ABSTRACT

A method of improving smoothness of an item to be washed during washing, including the step of washing the item with a washing liquid under conditions where an organic polymer having spinnability is present in the washing liquid; a process for hand-washing including the step of hand-washing an item to be washed with a washing liquid showing spinnability containing an organic polymer having spinnability, or a washing liquid prepared by diluting the washing liquid with more than 1-fold to 1,000-fold amount of water; a detergent composition containing an organic polymer having spinnability having an average molecular weight of 1,500,000 or more in an amount exceeding 0.1% by weight of the detergent composition; a laundry detergent composition comprising a polymer having an average molecular weight of 500,000 or more, wherein 60% by mole or more of constituting monomers has a sulfonic acid group or a salt form thereof, or a sulfuric acid group or a salt form thereof. The detergent composition of the present invention can be especially suitably used in hand-washing.

### TECHNICAL FIELD

The present invention relates to a method of improving smoothness of an item to be washed, a process for hand-washing, a detergent composition, a laundry detergent composition, and a creamy smoothness improver.

In addition, the present invention relates to a process for washing an item to be washed with the detergent composition, the laundry detergent composition or the creamy smoothness improver mentioned above.

### BACKGROUND ART

Washing methods can be roughly classified into two kinds: hand-washing and washing machine-washing. In recent years, with the widespread use of washing machines, washing machine-washing tends to be used increasingly. However, hand-washing is still carried out from the viewpoint of easy removal of dirt stains and economic advantages.

While hand-washing enables flexible washing conditions depending upon the washing situations such as the extent of removal of dirt stains and the kinds of items to be washed, physical and mental fatigue are involved in an individual who hand-washes, as compared to washing machine-washing. Especially, in “rub-washing” wherein the items to be washed are rubbed against each other, mechanical forces can be directly applied to sites to be washed, thus being one of the most natural processes for hand-washing. However, a long-period of work would be burdensome to an individual who hand-washes.

In addition, since the surface of the items to be washed, such as clothes, is not smooth microscopically, resistance is generated when these clothes are actually rubbed together. This resistance is felt by the individual who washes as unpleasant factors, such as “rough texture” and “squeakiness,” and increases the burden applied physically to the individual from the viewpoint of exhaustion of physical strength by the rub-washing movement. In addition, the local friction generated during rub-washing cause scratches or cuts on the hands of the individual, which in turn appear as wear on fibers, a so-called “cloth-damage” to the items to be washed. The damage on fibers not only shorten the duration period of clothes but also serve as an accelerating factor with respect to adhesion of dirt stains, thereby further increasing the physical burden required for washing.

In addition, this frictional resistance in the washing machine-washing causes damage on fibers generated by the mechanical forces such as agitation, and the loss of shape.

On the other hand, conventionally, technological developments have been made by remarking mainly on the aspect of “how to remove adhered dirt stains from an item to be washed,” such as improvement of detergency of a detergent or prevention of the redeposition on the washed laundry such as clothes, or the aspect of “how to finish the washed laundry,” such as imparting a softening property to the washed laundry (see, for instance, Patent Publications 1, 2, 3, and 4). Taking into consideration the unpleasant factors and physical burden generated during the hand-washing as mentioned above, i.e. “mental and physical burden for an individual who washes,” the technological developments focusing on the improvements thereon to reduce the burdens have not been so far made.

Patent Publication 1: JP-A-Hei 5-508889

Patent Publication 2: JP-B-2620318

Patent Publication 3: JP-A-Hei 7-216389

Patent Publication 4: JP-2002-538289 A

### DISCLOSURE OF THE INVENTION

### Problems to be Solved by the Invention

In view of focusing on the above matters, an object of the present invention is to provide a method of improving smoothness of an item to be washed during hand-washing carried out in households; a process for washing an item to be washed which is capable of reducing unpleasant factors such as “rough texture” and “squeaking” and physical fatigue, and providing hand-care and washing item-care; a detergent composition for realizing the method or process mentioned above; and a creamy smoothness improver.

In addition, an object of the present invention is to provide a laundry detergent composition capable of reducing unpleasant factors such as “rough texture” and “squeaking” and physical fatigue, without worsening the redeposition preventing property, and providing hand scratch-prevention and laundry-care for an item to be washed; a creamy smoothness improver; and a process for washing with the laundry detergent composition or creamy smoothness improver mentioned above.

### MEANS TO SOLVE THE PROBLEMS

The present invention relates to:

[1] a method of improving smoothness of an item to be washed during washing, comprising the step of washing the item with a washing liquid under conditions where an organic polymer having spinnability is present in the washing liquid;

[2] a method of improving smoothness of an item to be washed during hand-washing, comprising the step of hand-washing the item with a washing liquid under conditions where an organic polymer having spinnability is present in the washing liquid;

[3] a process for hand-washing comprising the step of hand-washing an item to be washed with a washing liquid showing spinnability comprising an organic polymer having spinnability, or with a washing liquid prepared by diluting the washing liquid with more than 1-fold to 1,000-fold amount of water;

[4] the process according to the above item [3], wherein the washing liquid has a pH of 9.0 or more;

[5] a detergent composition for improving smoothness, comprising an organic polymer having spinnability having an average molecular weight of 1,500,000 or more in an amount exceeding 0.1% by weight of the detergent composition;

[6] the detergent composition according to the above item [5], wherein the detergent composition comprises:

(a) an organic polymer having spinnability having an average molecular weight of 1,500,000 or more in an amount exceeding 0.1% by weight;

(b) a surfactant;

(c) an alkalizing agent; and

(d) a metal ion capturing agent;

[7] the detergent composition according to the above item [5], wherein the detergent composition comprises:

(a) a polyethylene oxide having spinnability having an average molecular weight of 1,500,000 or more in an amount exceeding 0.1% by weight;

(b-1) an anionic surfactant in an amount of 10% or more;

(c) an alkalizing agent; and

(d) a metal ion capturing agent,

wherein the detergent composition essentially consists of no polyoxyethylene alkyl ether (b-2);

[8] the detergent composition according to any one of the above items [5] to [7], wherein the detergent composition is in a powdery form or granular form;

[9] the detergent composition according to any one of the above items [5] to [8], further comprising an inorganic salt capable of releasing hydrogen peroxide in water, wherein the inorganic salt is contained in an amount of 15% by weight or less of the detergent composition;

[10] a laundry detergent composition comprising a polymer having an average molecular weight of 500,000 or more, wherein 60% by mole or more of constituting monomers have a sulfonic acid group or a salt form thereof, or a sulfuric acid group or a salt form thereof;

[11] the laundry detergent composition according to the above item [10], wherein the laundry detergent composition is in a powdery form or granular form;

[12] the laundry detergent composition according to the above item [10] or [11], wherein the detergent composition comprises:

(a′) a polymer having an average molecular weight of 500,000 or more, wherein 60% by mole or more of constituting monomers have a sulfonic acid group or a salt form thereof, or sulfuric acid group or a salt form thereof;

(b) a surfactant;

(c) an alkalizing agent; and

(d) a metal ion capturing agent;

[13] the laundry detergent composition according to any one of the above items [10] to [12], wherein the constituting monomer is a unit derived from one or more monomers selected from the group consisting of 2-acrylamide-2-methylpropanesulfonic acid and a salt thereof, and styrenesulfonic acid and a salt thereof;

[14] a creamy smoothness improver comprising an organic polymer having spinnability having an average molecular weight of 1,500,000 or more in an amount exceeding 0.1% by weight of the creamy smoothness improver;

[15] the creamy smoothness improver according to the above item [14], wherein the organic polymer is a polymer or copolymer made of a monomer selected from the group consisting of acrylic acid, acrylamide, acrylamide methylpropanesulfonic acid, dimethylaminoethyl methacrylic acid, vinyl alcohol, and mixtures thereof; a polysaccharide having a sugar backbone; or a polypeptide;

[16] the creamy smoothness improver according to the above item [14], wherein the organic polymer is a polyethylene oxide, and essentially consists of no polyoxyalkylene alkyl ether;

[17] a creamy smoothness improver comprising a polymer having an average molecular weight of 500,000 or more, wherein 60% by mole or more of constituting monomers have a sulfonic acid group or a salt form thereof, or sulfuric acid group or a salt form thereof;

[18] the creamy smoothness improver according to the above item [17], wherein the constituting monomer is a unit derived from one or more monomers selected from the group consisting of 2-acrylamide-2-methylpropanesulfonic acid or a salt thereof, and styrenesulfonic acid or a salt thereof;

[19] a process for washing an item to be washed with the laundry detergent composition as defined in the above item [10]; and

[20] a process for washing an item to be washed with the creamy smoothness improver as defined in the above item [17].

### EFFECTS OF THE INVENTION

By using the process for washing an item to be washed, the detergent composition or the laundry detergent composition of the present invention, there is exhibited an effect that conventional washing, especially hand-washing, can be carried out in households as a more pleasant experience. Specifically, according to the present invention, there are exhibited some effects that the feel during hand-washing is improved, that at the same time physical burdens are lessened, and that further laundry-care and abrasion prevention can be accomplished.

### BEST MODE FOR CARRYING OUT THE INVENTION

A conventional detergent component such as a surfactant or a low-molecular weight polymer formulated as a dispersant for dirt stains and carbon stains, such as sodium polyacrylate or polyethylene glycol, might show a lubricating effect under special conditions, for instance, a very highly concentrated system (for instance, a liquid mixture having a concentration of 100 g/L as a concentration of the base components). However, in a concentration of a washing liquid which is usually employed (for instance, a liquid mixture having a concentration of 0.05 to 10.0 g/L as a concentration of the base components), there are no such lubricating effects, or even if there is a slight effect, the effect is insufficient for eliminating the above-mentioned disadvantages when hand-washing is carried out. For instance, there has been known that some compounds have an effect of reducing friction between fibers, such as the silicone compound polymers described in JP-A-Hei 5-508889 mentioned above. However, a user still may not feel especially significant changes in feel when rub-washing with a washing liquid at a concentration usually employed. Therefore, hand-washing does not become a pleasant experience for the user by the effects of these base components alone. In addition, the silicone compound polymers are a kind of a surface-coating oil agent having spreadability for reducing friction on the fiber surface during drying, and these polymers do not provide sufficient effects from the viewpoint of preventing fiber damage generated during rub-washing when the polymers are used in the form of an aqueous solution, i.e. a washing liquid.

In order that hand-washing is carried out as a pleasant experience in households, it is necessary that smoothness of an item to be washed can be realized in a washing liquid at a usual concentration.

As a result of intensive studies for the needs for carrying out hand-washing as a more pleasant experience, the present inventors have found that specific smoothness can be obtained when especially rubbing items to be washed with each other by adding a specified organic polymer to a washing liquid and carrying out hand-washing, and thereby feel during hand-washing is improved, and at the same time the physical burden is lessened, whereby further accomplishing laundry-care and hand-care.

Also, the present inventors have found that those polymers having specified functional groups among the organic polymers are especially excellent from the viewpoint of the redeposition preventing property of the detergent composition.

In addition, the present inventors have found that the smoothness serves to prevent laundry damage during washing of the laundry items in a washing machine by adding this organic polymer to a washing liquid, and to prevent entanglement and deformation of the shape of the laundry in the washing machine because the smoothness is generated between laundry items and fibers, thereby providing a laundry-care effect such as prevention of loss of its shape.

These and other advantages of the present invention will be apparent from the following description.

1. Method of Improving Smoothness

One of the important features of the method of improving smoothness during washing of an item to be washed (hereinafter simply referred to as “method of improving smoothness”) of the present invention resides in that the method includes the step of washing the item with a washing liquid under conditions where an organic polymer having spinnability (hereinafter also referred to as “spinnable organic polymer”) is present in the washing liquid. For instance, the method can be carried out with a washing liquid prepared by previously adding a detergent composition containing a spinnable organic polymer to water to dissolve, or separately adding a spinnable organic polymer to a washing liquid without containing the spinnable organic polymer during washing. The smoothness of the items to be washed can be remarkably improved by using the method having the above feature.

The term “washing liquid” as used herein refers to a water-based liquid composition for carrying out washing of laundry clothes, in which a detergent composition is dissolved or suspended.

The phrase “improving smoothness” as used herein refers to reduction in friction generated between clothes or between fibers or the like in a washing liquid or in a state where the clothes or fibers contain the washing liquid during washing. Especially during hand-washing, the smoothness can be exhibited as a degree of resistance received (felt) by hands of an individual who washes during rub-washing of the items to be washed. Therefore, with the improvement in smoothness, this receiving or feel of the resistance is reduced, so that the items to be washed can be rubbed against each other very smoothly.

Specifically, the case as described below is said as “improving smoothness.” When a washing liquid has a smaller resistance felt by hands when rub-washing clothes or pieces of cloths by hand, in other words, smoothness is even higher and a squeaky feel is even smaller in a pair comparison with a washing liquid not containing the organic polymer, it is said that the smoothness is improved (by using the washing liquid). Here, as the washing liquid not containing the organic polymer, a washing liquid obtained, for instance, by dissolving the composition obtained in Preparation Example I-1 in accordance with the method described in <Method for Testing Hand-Washing> can be used. Also, as the method for rub-washing, the method described in <Method for Testing Hand-Washing> can be used.

Specifically, an individual who washes in accordance with the method of improving smoothness of the present invention gets a feel of a soft “layer” on the surface of the items to be washed during washing when finger tips or the like touch the surface. This feel is exhibited by the spinnable organic polymer added to the washing liquid. In this respect, it is presumed that the layer or a part thereof plays a role as a lubricating layer, so that the contacted items to be washed are considered to provide a “smooth” feel with each other. In the present invention, since this layer exists in the item to be washed during washing, and “smoothness” is generated during rub-washing, washing as a pleasant experience can be realized.

Furthermore, there are exhibited an effect of suppressing cuts and scratches on hands generated by rubbing items to be washed with hands (so-called abrasion reducing effect), and an effect of suppressing damage on fibers of an item to be washed (so-called laundry damage-care effect).

[Definition of Spinnability]

The term “spinnability” as used herein means a property of showing an extension property of an object, i.e. a so-called “stringy” property, and a remarkable example thereof includes, for instance, stringiness (spinnability) of fermented soybeans and the like.

The spinnability is a property of showing a continuous thread-like structure without breaking droplets when a liquid composition is dripped (or spilled) at a low rate or a liquid composition is extended with holding one end of the liquid composition. An example thereof includes, for instance, stringiness of a viscous mucus of animals or plants, and the like. Incidentally, the spinnability has been known as one of the elastic relaxation phenomena of the liquid composition, and is completely independent from surface tension or viscosity. Even in case of a usual polymer solution, the polymer solution may often show the above-mentioned spinnable behavior, as long as the polymer concentration is, for instance, as high as 100 g/L or more as mentioned above. However, the polymer solution described above shows such a very high viscosity that the polymer solution is remarkably disadvantageous in flowability. The spinnability in the present invention refers to the spinnability which can be exhibited by a water-based liquid composition of a certain organic polymer in a very dilute concentration, while keeping high flowability.

[Definition of Spinnability of Organic Polymer]

The spinnable organic polymer as used herein refers to an organic polymer of which aqueous solution shows the spinnability in the present invention as mentioned above. This spinnable organic polymer is generally different from the organic polymer with a high molecular weight which exhibits a so-called “thickening effect.”

In the present invention, the spinnable organic polymer is preferably an organic polymer of which aqueous solution with a concentration of 30.0 g/L or less shows spinnability, more preferably an aqueous solution with a concentration of 10 g/L or less shows spinnability, and even more preferably an aqueous solution with a concentration of 5 g/L or less shows spinnability.

In the present invention, the presence or absence of spinnability of the organic polymer is determined in accordance with the following method. An aqueous mixed solution was prepared by adding to an aqueous solution containing 0.07% by weight of sodium dodecylbenzenesulfonate and 0.07% by weight of anhydrous sodium carbonate, an organic polymer at a concentration so that the viscosity in the aqueous mixed solution is about 500 mPa·s, about 200 mPa·s, about 100 mPa·s, or about 20 mPa·s as determined with a B-type viscometer at 25° C. (0° DH, 60 r/min). The spinnability of the resulting aqueous mixed solution is judged in accordance with the method described in the following [Judgment Method for Spinnability]. When the aqueous mixed solution is judged to have spinnability in any of the solution with viscosities described above, the organic polymer is considered as a spinnable organic polymer.

[Judgment Method for Spinnability]

An aqueous solution showing stringiness (spinnability) when gently dripped from the tip end (inner-diameter: 1 mm) of a Pasteur Pipette (glass, for instance, ASAHITECHNO GLASS, IK-PAS-5P) is defined as an aqueous solution showing spinnability in the present invention. Here, a solution showing longer strings is defined as an aqueous solution having stronger (or higher) spinnability. The aqueous solution is used in the judgment method at 25° C. after thoroughly stirring the solution, and the dropwise procedure is carried out by placing the tip end of the Pasteur pipette at least 5 mm away from a point to which the aqueous solution is dripped. Regarding the aqueous solution having strong spinnability, the spinnability can be more easily confirmed when the dripping procedure is carried out from an even higher position. The dripping procedure may be carried out for several times and confirmed. The “string” confirmed during the dripping procedure is one finer than 1 mm in diameter. This spinnability can also be determined by an equipment such as Capillary Breakup Extensional Rheometer (CaBER1), manufactured by Thermo HAAKE.

The higher the effect of providing spinnability, namely the higher the spinnability of the polymer, the “smoothness” can be realized at an intended, even lower concentration. When the washing liquid has spinnability, an even higher “smoothness” can be realized. Even in the case where a washing liquid is not even found to have spinnability, by adding a polymer having the ability of providing spinnability to an aqueous solution to a washing liquid, the intended “smoothness” can be obtained.

The spinnable organic polymer of the present invention is a compound not usually used in a detergent composition. The spinnable organic polymer includes cross-linking polymers and non-cross-linking polymers. Among the spinnable organic polymers, the non-crosslinking polymer has a higher spinnability, and is preferable in the present invention.

Specific examples of the spinnable organic polymer include a polymer or copolymer made of one or more monomers selected from the group consisting of ethylene oxide, acrylic acid, acrylamide, 2-acrylamide-2-methylpropanesulfonic acid, dimethylaminoethyl methacrylic acid, vinyl alcohol, and amino acids such as glutamic acid and aspartic acid; a polysaccharide having a sugar backbone such as starch, hydroxyethyl cellulose (HEC), carboxymethyl cellulose (CMC), hydroxypropylmethyl cellulose (HPMC), and hyaluronic acid. Among them, the polymer or copolymer made of one or more monomers selected from the group consisting of ethylene oxide, acrylic acid, acrylamide, 2-acrylamide-2-methylpropanesulfonic acid, dimethylaminoethyl methacrylic acid, vinyl alcohol, amino acids such as glutamic acid and aspartic acid; and a polysaccharide having a sugar backbone such as starch, hydroxyethyl cellulose (HEC), or hydroxypropylmethyl cellulose (HPMC), is preferable. An acrylic acid polymer or a salt thereof, an acrylamide polymer, a polymer of 2-acrylamide-2-methylpropanesulfonic acid or a salt thereof, a copolymer of acrylic acid and 2-acrylamide-2-methylpropanesulfonic acid or a salt thereof, a polyethylene oxide and hydroxypropylmethyl cellulose are more preferable. From the viewpoint of economic advantages and the like, the acrylic acid polymer or a salt thereof, an acrylamide polymer, the polymer of 2-acrylamide-2-methylpropanesulfonic acid or a salt thereof, the copolymer of acrylic acid and 2-acrylamide-2-methylpropanesulfonic acid or a salt thereof, and the polyethylene oxide are preferable.

Here, the polyethylene oxide exhibits high smoothness as the spinnable polymer of the present invention. However, the polyethylene oxide loses its ability of imparting smoothness by a specific interaction in the co-presence with a polyoxyethylene alkyl ether, which is a nonionic surfactant, in the washing liquid. Therefore, in the method of improving smoothness of the present invention, when the spinnable organic polymer is a polyethylene oxide, the washing liquid essentially consists of no polyoxyethylene alkyl ether. It is preferable that the washing liquid essentially consists of no polyoxyalkylene alkyl ether and polyoxyethylene alkyl phenyl ether. The expression “essentially consists of no” as used herein means that the compound is contained at a concentration of the washing liquid of 100 mg/L or less. It is more preferable that the compound is contained at a concentration of 70 mg/L or less, more preferably 50 mg/L or less, more preferably 30 mg/L or less, and most preferably not contained in the washing liquid. Also, the weight ratio of the compound to the polyethylene oxide is preferably 12-folds or less, more preferably 10-folds or less, more preferably 5-folds or less, more preferably 1-fold or less, and most preferably not contained in the washing liquid.

Incidentally, the cross-linking acrylic polymer (Aqupec manufactured by Sumitomo Seika Co., Ltd., Carbopol manufactured by BF Goodrich, and the like), which is used as a thickening agent for a liquid detergent or the like in many cases, is one in which spinnability is suppressed even in a thickening system where its aqueous solution shows thixotropic properties, which are judged as the organic polymer not having spinnability in the present invention.

The spinnable organic polymer may be alone or together with another compound formed into a preparation as a creamy smoothness improver, from the viewpoint of separately adding the spinnable organic polymer to other detergent components. In addition, the spinnable organic polymer may be used alone, or two or more kinds of the organic polymers can be simultaneously used as a creamy smoothness improver. In addition, these spinnable organic polymers can be added by including the spinnable organic polymer in the detergent composition.

In the method of improving smoothness of the present invention, the amount of the spinnable organic polymer which is present in the washing liquid, is preferably from 2 mg/L or more, more preferably from 5 mg/L or more, even more preferably from 10 mg/L or more, even more preferably from 20 mg/L or more, and even more preferably from 50 mg/L or more, from the viewpoint of providing smoothness. The timing for the addition of the spinnable organic polymer to the washing liquid is not particularly limited, and includes immediately before hand-washing, during hand-washing, before starting soaking when soak-and-washing, and the like. In addition, the method for adding a spinnable organic polymer includes a method including the step of adding the polymer as it is; a method including the step of adding a solution prepared by previously dissolving the polymer to a solvent such as water; a method including the step of mixing the polymer with other compounds to form a preparation in the form of a powder, liquid, gel or the like, and adding the preparation; a method including the step of granulating the polymer; a method including the step of incorporating the polymer into a detergent composition in each form of liquid, gel, paste, powder, granule or a secondary-molded product thereof, such as a tablet or in a doughy shape; and the like. The detergent composition containing a spinnable organic polymer may be added to water to dissolve to provide a washing liquid, or a spinnable organic polymer may be added to a previously prepared washing liquid in accordance with the method mentioned above. In any of the cases, the amount of the detergent composition in the washing liquid is not particularly limited.

When a detergent composition containing a spinnable organic polymer may be added to water to dissolve to provide a washing liquid, the process for preparing the detergent composition containing a spinnable organic polymer is not particularly limited. The detergent composition may be prepared in accordance with the methods described in Tokkyocho Koho: Shuchi Kanyo Gijutsu Shu (Clothes Powder Detergent: Japanese Patent Office), 10(1998)-25(7159), and JP-B-3123757, which have been known as general processes for preparing detergent compositions. Alternatively, the detergent composition may be prepared by preparing detergent components other than the spinnable organic polymer in accordance with the methods mentioned above, and thereafter mixing the resulting detergent composition with the spinnable organic polymer. During the mixing, the spinnable organic polymer may be alone granulated and mixed, or granulated together with other compounds to provide a granular powder and then mixed, or may be prepared into a liquid or gel-like form, and then mixed. During the mixing, the components other than the spinnable organic polymer contained in the detergent composition and the form of the detergent composition are not particularly limited.

In the method of improving smoothness of the present invention, the environments for carrying out washing, the kinds of items to be washed, the amount of an item to be washed, the amount of the washing liquid, and further the size of a container in a case where washing is carried out in a container and the like are not particularly limited. For instance, when a washbowl is used, the larger the washbowl, the larger the amount of the washing liquid, and the lower the goods-liquor ratio (weight ratio of item to be washed/washing liquid), the more easily recognizable the smoothness. In terms of the size, the washbowl is preferably one having a diameter of 25 cm or more, more preferably 30 cm or more, even more preferably 40 cm or more, and even more preferably 50 cm or more. The goods-liquor ratio is preferably 1/3 or less, more preferably 1/5 or less, even more preferably 1/7 or less, and even more preferably 1/10 or less. In addition, the higher the temperature, the more excellent the dissolubility in many of the spinnable organic polymers. Also, the temperature of the washing liquid is preferably 10° C. or higher, more preferably 20° C. or higher, even more preferably 25° C. or higher, and even more preferably 30° C. or higher. In addition, the method for hand-washing is not particularly limited as long as it is a method for washing an item to be washed by hand.

2. Process for Hand-Washing

In addition, the present invention relates to a process for hand-washing. A preferred process for hand-washing in the present invention (hereinafter referred to as “process for hand-washing of the present invention”) is one in which the method of improving smoothness of the present invention, including the step of hand-washing an item to be washed with a washing liquid showing spinnability used in the present invention as described later, is applied to the process. By carrying out the process for hand-washing mentioned above, a highly excellent effect of improving smoothness can be obtained. According to the process for hand-washing, there is exhibited an effect that feel is improved, so that hand-washing is realized as a pleasant experience. Furthermore, there are exhibited a so-called abrasion preventing effect, an effect of suppressing cuts, scratches and the like on hands generated by rubbing an item to be washed by hand, and a so-called laundry damage-care effect, an effect of suppressing damage on fibers and the like of an item to be washed.

The washing liquid in the process for hand-washing of the present invention refers to (i) a washing liquid that shows spinnability during hand-washing containing the spinnable organic polymer, or (ii) a washing liquid prepared by diluting the above washing liquid (i) with more than 1-fold to 1,000-fold amount of water.

Here, although the washing liquid prepared by diluting the washing liquid having spinnability with more than 1-fold to 1,000-fold amount of water no longer shows spinnability in some cases, since the spinnable organic polymer in the present invention showing lubricity is also present in a liquid layer between clothes in the washing liquid, the above-mentioned effect of improving smoothness of the present invention can be realized during hand-washing. Therefore, the washing liquid showing spinnability of the present invention is essentially completely different from an aqueous solution of which viscosity is simply increased or a dilute solution thereof. The presence or absence of spinnability of the washing liquid is judged in accordance with the method described in [Judging Method for Spinnability] above.

The washing liquid showing spinnability can be obtained, for instance, by adding to a washing liquid a spinnable organic polymer as a part of the detergent components, or separately from the detergent components.

In the present invention, the larger the molecular weight of the spinnable organic polymer or the larger the content of the spinnable organic polymer in the washing liquid, the more enhanced the effect for improving smoothness, thereby realizing washing as a more pleasant experience.

The washing liquid showing spinnability in the present invention may be used in washing after diluting the washing liquid (i) as mentioned above. The concentration after the dilution is preferably 1/1,000 or more of the lower limit of the concentration showing spinnability, more preferably 1/500 or more, even more preferably 1/200 or more, even more preferably 1/100 or more, even more preferably 1/50 or more, and even more preferably 1/20 or more, from the viewpoint of the effect of improving smoothness. In addition, in order to obtain an even higher effect for improving smoothness, it is preferable that the washing liquid showing spinnability of the present invention is used under concentration conditions where the spinnability is sufficiently shown. The concentration of the washing liquid is preferably 500-fold amount or less of the lower limit of the concentration showing spinnability, more preferably 100-fold amount or less, more preferably 50-fold amount or less, even more preferably 20-fold amount or less, even more preferably 10-fold amount or less, even more preferably 5-fold amount or less, even more preferably 2-fold amount or less, and even more preferably 1-fold amount or less, from the viewpoint of the handling property of the washing liquid and economic advantage.

The concentration of the spinnable organic polymer in the washing liquid is preferably 2 mg/L or more, more preferably 5 mg/L or more, even more preferably 10 mg/L or more, even more preferably 20 mg/L or more, and even more preferably 50 mg/L or more, from the viewpoint of obtaining a high effect of improving smoothness. In addition, the concentration of the spinnable organic polymer in the washing liquid is preferably 5,000 mg/L or less, more preferably 2,500 mg/L or less, even more preferably 1,000 mg/L or less, even more preferably 500 mg/L or less, and even more preferably 250 mg/L or less, from the viewpoint of the handling property as a solution.

The pH of the washing liquid is preferably 9.0 or more, more preferably 9.5 or more, and even more preferably 10.0 or more, from the viewpoint of detergency. Here, the pH of the washing liquid is determined in a washing liquid having water hardness of 0° DH at a temperature of 25° C. without supplying clothes therein. The upper limit of the pH is preferably 11.0 or less, from the viewpoint of stability, prevention of chappy hands and the like.

The washing liquid as used herein refers to a solution for carrying out washing in which a detergent composition is dissolved, suspended or the like. Here, the components other than the organic polymer contained in the detergent composition, the form of the detergent composition, and the process for preparing the detergent composition are not particularly limited, and may be the same as those used in the above-mentioned method of improving smoothness.

In addition, in the process for hand-washing of the present invention, the environments for carrying out hand-washing, the kinds of items to be washed, the amount of an item to be washed, the amount of water, temperature, or the size of a container in a case where washing is carried out in a container, and the like are not particularly limited, in the same manner as the above-mentioned method of improving smoothness of the present invention. The effects can be exhibited in all sorts of environments. The preferred washing conditions may be also the same as those described in the above-mentioned method of improving smoothness.

3. Detergent Composition

In addition, the present invention relates to a detergent composition.

The detergent composition of the present invention can be classified into the following two embodiments:

(Embodiment 1) A detergent composition containing an organic polymer having spinnability having an average molecular weight of 1,500,000 or more in an amount exceeding 0.1% by weight of the detergent composition.

(Embodiment 2) A laundry detergent composition containing a polymer having an average molecular weight of 500,000 or more, wherein 60% by mole or more of constituting monomers has a sulfonic acid group or a salt form thereof, or a sulfuric acid group or a salt form thereof.

### Embodiment 1

One of the important features of the detergent composition of Embodiment 1 resides in that the detergent composition contains an organic polymer having spinnability having an average molecular weight of 1,500,000 or more in an amount exceeding 0.1% by weight of the detergent composition. Since the detergent composition has the above feature, there are exhibited some effects that the feel in hand-washing is improved when the detergent composition is used for hand-washing in households, at the same time that physical burdens are lessened, and further that laundry-care and abrasion reduction can be accomplished.

Also, when the detergent composition is used in a washing machine-washing, there are some laundry-care effects in which smoothness serves to prevent clothes damage and provides smoothness between the clothes to prevent entanglement of the laundry clothes in the washing machine, thereby preventing loss of shape.

In addition, the present invention relates to a detergent composition for improving smoothness (hereinafter referred to as the detergent composition of the present invention).

Among them, the preferred detergent composition of Embodiment 1 contains:

(a) an organic polymer having spinnability having an average molecular weight of 1,500,000 or more in an amount exceeding 0.1% by weight;

(b) a surfactant;

(c) an alkalizing agent; and

(d) a metal ion capturing agent,

from the viewpoint of satisfying both detergency and impartment of smoothness.

In addition, for the reasons given in the method of improving smoothness, when the spinnable organic polymer is a polyethylene oxide, it is preferable that the detergent composition contains:

(a) a polyethylene oxide having spinnability having an average molecular weight of 1,500,000 or more in an amount exceeding 0.1% by weight;

(b-1) an anionic surfactant in an amount of 10% or more;

(c) an alkalizing agent; and

(d) a metal ion capturing agent,

wherein the detergent composition essentially consists of no polyoxyethylene alkyl ether (b-2).

The phrase “essentially consists of no polyoxyethylene alkyl ether” as used herein means that the compound is contained in an amount of 0% or more and less than 2%.

### Embodiment 2

In addition, the detergent composition of Embodiment 2 is concerned with a laundry detergent composition (hereinafter referred to as “the detergent composition of Embodiment 2”). One of the important features of the detergent composition of Embodiment 2 resides in that the detergent composition contains a polymer having an average molecular weight of 500,000 or more, wherein 60% by mole or more of constituting monomers have a sulfonic acid group or a salt form thereof, or a sulfuric acid group or a salt form thereof (hereinafter referred to as “the polymer having a sulfonic acid group and/or a sulfuric acid group). Since the detergent composition has the above feature, there are exhibited some effects that the feel in hand-washing is improved when the detergent composition is used for hand-washing in households, at the same time that physical burdens are lessened, and further that laundry-care and hand-care can be accomplished without worsening the redeposition preventing property.

In addition, when the detergent composition is used in washing machine-washing, there are some laundry-care effects that smoothness serves to prevent clothes damage and smoothen between the clothes or fibers to prevent entanglement and deformation of the laundry clothes in the washing machine, thereby preventing loss of its shape.

The preferred detergent composition of Embodiment 2 contains:

(a′) a polymer having an average molecular weight of 500,000 or more, wherein 60% by mole or more of constituting monomers have a sulfonic acid group or a salt form thereof, or sulfuric acid group or a salt form thereof;

(b) a surfactant;

(c) an alkalizing agent; and

(d) a metal ion capturing agent,

from the viewpoint of satisfying both detergency and impartment of smoothness.

The detergent composition of the present invention shown in Embodiment 1 or 2 may take any form such as a powder, granule, liquid or paste, or in the alternative, the detergent composition may be molded into an aggregate, a tablet, a dough or the like by a secondary process. It is preferable that the detergent composition contains an alkalizing agent and a metal ion capturing agent together with a surfactant from the viewpoint of detergency. In addition, it is preferable that the base agent is quickly dispersed during the dissolution from the viewpoint of the dissolubility of the detergent composition. From these viewpoints, it is preferable that the detergent composition is in the form of a powder or granule. In addition, the spinnable organic polymer or the polymer having a sulfonic acid group and/or a sulfuric acid group in the present invention is mostly in the form of a powder or granule. Therefore, the formation of a preparation is facilitated by making the detergent composition into the form of a powder or granule, so that the degree of freedom of the polymer formulated is more increased.

The process for preparing the detergent composition of the present invention is not particularly limited. The detergent composition may be prepared in accordance with the methods described in Tokkyocho Koho: Shuchi Kanyo Gijutsu Shu (Clothes Powder Detergent: Japanese Patent Office), 10(1998)-25(7159), and JP-B-3123757, which have been known as general processes for preparing detergent compositions. Alternatively, the detergent composition may be prepared by preparing detergent components other than the spinnable organic polymer or the polymer having a sulfonic acid group and/or a sulfuric acid group in accordance with the methods mentioned above, and thereafter mixing the resulting detergent composition with the spinnable organic polymer or the polymer having a sulfonic acid group and/or a sulfuric acid group.

Incidentally, the detergent composition of the present invention shown in Embodiment 1 or 2 can be suitably used for the method of improving smoothness of the present invention and the process for hand-washing of the present invention mentioned above.

When the detergent composition of the present invention shown in Embodiment 1 or 2 is used for the method of improving smoothness of the present invention and the process for hand-washing of the present invention, the detergent composition can be those used in a generally employed method and concentration as a detergent generally used in hand-washing or washing machine-washing. The concentration of the detergent composition of Embodiment 1 in the washing liquid, in the case of hand-washing, is preferably 0.05 g/L or more, more preferably 0.1 g/L or more, even more preferably 0.5 g/L or more, even more preferably 1 g/L or more, even more preferably 2 g/L or more, and even more preferably 3 g/L or more, from the viewpoint of improving smoothness of the washing liquid. On the other hand, the concentration of the detergent composition in the washing liquid is preferably 20 g/L or less, more preferably 15 g/L or less, and even more preferably 10 g/L or less, from the viewpoint of rinsability and handling property of the washing liquid. It is even more preferable to use the detergent composition in a concentration of from 0.5 to 10 g/L. In addition, the preferable use method includes a method of rub-washing in which a washing liquid is prepared by sprinkling a proper amount of the detergent composition of the present invention directly to a part of laundry clothes to be washed subjected to rub-washing, and contacting the laundry clothes with water. A combined use of the detergent composition of the present invention with a detergent composition other than the detergent composition of the present invention or with a laundry-care composition not containing detergent components, such as a perfume composition is also preferable.

Each of the components usable in the present invention will be described hereinbelow.

4. Spinnable Organic Polymer, and Polymer Having Sulfonic Acid Group and/or Sulfuric Acid Group

In the detergent composition of the present invention, the effect of improving smoothness of the present invention can be obtained by using the spinnable organic polymer described in the method of improving smoothness of the present invention. As the spinnable organic polymer, a water-soluble organic polymer having an average molecular weight of 1,500,000 or more is preferably used. The larger the average molecular weight of the spinnable organic polymer, the smaller the amount of the organic polymer necessary, so that the intended “smoothness” can be realized. As long as the organic polymer is a spinnable organic polymer having an average molecular weight of 1,500,000 or more, sufficient smoothness can be imparted to a liquid mixture, even in the case of ones having a low solute concentration as in the case of the washing liquid. The spinnable organic polymer has an average molecular weight of preferably 2,000,000 or more, more preferably 2,500,000 or more, and even more preferably 3,000,000 or more, from the viewpoint of realizing sufficient “smoothness” even at a more dilute concentration. On the other hand, the spinnable organic polymer has an average molecular weight of preferably 100,000,000 or less, more preferably 30,000,000 or less, and even more preferably 20,000,000 or less, from the viewpoint of dissolubility.

The polymer having a sulfonic acid group and/or a sulfuric acid group in the present invention may be a vinyl polymer, a polycondensed polymer or a polyether-based polymer.

In the case where the polymer having a sulfonic acid group and/or a sulfuric acid group in the present invention is a vinyl polymer, a vinyl constituent monomer having a sulfonic acid group and/or a salt form thereof, or a sulfuric acid group and/or a salt form thereof, which is its monomer unit, includes, for instance, a unit derived from a monomer such as 2-(meth)acryloyloxyethanesulfonic acid, 2-(meth)acryloyloxypropanesulfonic acid, 2-(meth)acrylamide-2-alkyl(number of carbon atoms: 1 to 4)propanesulfonic acid, vinylsulfonic acid, allylsulfonic acid, styrenesulfonic acid, or vinylsulfuric acid. Among them, from the viewpoint of high polymerizability so that a high-molecular weight polymer can be easily obtained, a unit derived from 2-(meth)acryloyloxyethanesulfonic acid, 2-(meth)acryloyloxypropanesulfonic acid, 2-(meth)acrylamide-2-alkyl(number of carbon atoms: 1 to 4)propanesulfonic acid, or styrenesulfonic acid is preferable, a unit derived from 2-acrylamide-2-methylpropanesulfonic acid or styrenesulfonic acid is more preferable, and a unit derived from 2-acrylamide-2-methylpropanesulfonic acid is even more preferable.

These constituting monomers may be used as a unit in an acid form, or a part or all of the sulfonic acid group and/or sulfuric acid group in the unit are neutralized to provide a unit in a salt form.

The counterion for forming a unit in the salt form of a sulfonic acid group or a sulfuric acid group includes a metal ion, an ammonium ion, an alkylammonium or alkenylammonium ion each having a total number of carbon atoms of 1 to 22, a pyridinium ion each having an alkyl or alkenyl group having a number of carbon atoms of 1 to 22, and an alkanolammonium ion having a total number of carbon atoms of 1 to 22. Alkali metal ions such as sodium ion and potassium ion, or ammonium ion is preferable, and sodium ion and potassium ion are more preferable.

In the polymer having a sulfonic acid group and/or a sulfuric acid group in the present invention, the above-mentioned constituting monomers may be used alone or in admixture of two or more kinds. When there are two or more kinds of the constituting monomers, the arrangements of these constituting monomers are not particularly limited, and random arrangements, alternating arrangements, and block arrangements may be employed.

In the case where the polymer having a sulfonic acid group and/or a sulfuric acid group in the present invention is a vinyl polymer, the process for preparing the vinyl polymer is not particularly limited, and a known process can be selected. For instance, a vinyl monomer having a sulfonic acid group (and/or a salt form thereof) and/or a sulfuric acid group (and/or a salt form thereof) may be subjected to homopolymerization, or the vinyl monomer may be copolymerized with other monomers not having a sulfonic acid group (and/or a salt form thereof) and/or a sulfuric acid group (and/or a salt form thereof) in a ratio such that the molar ratio of the vinyl monomer having a sulfonic acid group (and/or a salt form thereof) and/or a sulfuric acid group (and/or a salt form thereof) to the constituting monomers is 60% by mole or more. Alternatively, the sulfonic acid group (and/or a salt form thereof) and/or sulfuric acid group (and/or a salt form thereof) may be introduced to any known polymer in a ratio of 60% by mole or more of the constituting monomers.

In the case where the polymer having a sulfonic acid group and/or a sulfuric acid group in the present invention is a vinyl polymer, there can be employed homopolymerization or copolymerization of a monomer having a sulfonic acid group (and/or a salt form thereof) and/or a sulfuric acid group (and/or a salt form thereof) as a polymerization form to prepare the vinyl polymer. As a method for the polymerization, bulk polymerization or precipitation polymerization can be used. In order to obtain a polymer having an even higher ability of providing smoothness or to facilitate control of the polymerization, it is preferable as a method of polymerization, to prepare the vinyl polymer by an aqueous solution polymerization or by a reversed phase suspension polymerization.

In the case where the polymer having a sulfonic acid group and/or a sulfuric acid group in the present invention is a vinyl polymer, in the preparation of the vinyl polymer, the polymerization process may be any of the processes such as radical polymerization, anion polymerization and cation polymerization. In the case where the vinyl polymer is prepared by a radical polymerization, there may be used as a radical polymerization initiator a peroxide initiator such as potassium persulfate, ammonium persulfate, sodium persulfate, t-butyl hydroperoxide, or hydrogen peroxide, or an azo initiator such as 2,2′-azobis(2-amidinopropane)dihydrochloride. Alternatively, the radical polymerization initiator may be used as a redox initiator together with a reducing agent such as sodium sulfite, sodium hydrogensulfite, ferrous sulfate, or L-ascorbic acid. Also, a monomer may be irradiated with ultraviolet light, electron beams or γ-rays to initiate the polymerization. Here, the amount of these polymerization initiators used is preferably from 0.0001 to 5% by mole, more preferably from 0.001 to 1.5% by mole, and even more preferably from 0.01 to 0.5% by mole, of the above-mentioned vinyl monomer.

In addition, in the case where the vinyl polymer is prepared by an anion polymerization, as a polymerization initiator, an aromatic complex of an alkali metal such as naphthylsodium; an alkali metal such as lithium, sodium or potassium; or an organolithium compound (alkyllithium compound) such as n-butyllithium, t-butyllithium, methyllithium, or fluorenyllithium may be used, or an organomagnesium, preferably a Grignard compound such as phenylmagnesium bromide or butylmagnesium bromide, or a diorganomagnesium compound such as dibenzylmagnesium, dibutylmagnesium or benzylpicolylmagnesium may be used. Here, the amount of these polymerization initiators used is preferably from 0.0001 to 5% by mole, more preferably from 0.001 to 1.5% by mole, and even more preferably from 0.01 to 0.5% by mole, of the above-mentioned vinyl monomer.

On the other hand, in the case where the vinyl polymer is prepared by a cation polymerization, as a polymerization initiator, a Brønsted acid such as trifluoroacetic acid, trichloroacetic acid, sulfuric acid, methanesulfonic acid or trifluoromethanesulfonic acid may be used, or a Brønsted acid/Lewis acid mixture such as water/boron trifluoride, water/boron trichloride, water/aluminum chloride, water/aluminum bromide, water/tin tetrachloride, trichloroacetic acid/tin tetrachloride, hydrogen chloride/boron trichloride or hydrogen chloride/aluminum trichloride may be used. Alternatively, an organocation such as trityl cation or tropylium cation, or a mixture capable of generating an oxocarbenium ion such as acetyl chloride/silver hexafluoroantimonate or acetyl chloride/silver perchlorate may be used. Here, the amount of these polymerization initiators used is preferably from 0.0001 to 5% by mole, more preferably from 0.001 to 1.5% by mole, and even more preferably from 0.01 to 0.5% by mole, of the above-mentioned vinyl monomer.

In addition, the vinyl polymer is obtained as a copolymer formed between a monomer having a sulfonic acid group (and/or a salt form thereof) and/or a sulfuric acid group (and/or a salt form thereof) and other copolymerizable monomers. In this case, the constituting monomer other than the constituting monomer having a sulfonic acid group (and/or a salt form thereof) and/or a sulfuric acid group (and/or a salt form thereof) is not particularly limited, as long as the polymer having a sulfonic acid group and/or a sulfuric acid group can maintain its water solubility.

The copolymerizable monomer mentioned above can be exemplified as follows.

The copolymerizable monomer includes (meth)acrylic acid [wherein (meth)acrylic acid refers to acrylic acid, methacrylic acid or a mixture thereof] and salts thereof; styrenecarboxylic acids and salts thereof; maleic acid-based monomers [maleic anhydride, maleic acid, monoester of maleic acid, maleic acid monoamide, or a mixture of two or more kinds thereof] and salts thereof; itaconic acid and salts thereof; and the like. One or more kinds selected from these can be used. Among them, (meth)acrylic acid and salts thereof and styrenecarboxylic acids and salts thereof are preferable, and more preferably (meth)acrylic acid and salts thereof, from the viewpoint of facilitation in copolymerization. Here, the counterion for forming the salt may be the counterion as mentioned above.

Also, a vinyl constituting monomer having a phosphoric acid group (or a salt form thereof) or a phosphonic acid group (or a salt form thereof) may be copolymerized. The vinyl constituting monomer having a phosphoric acid group or a phosphonic acid group includes, for instance, a (meth)acryloyloxyalkyl(number of carbon atoms: 1 to 4) phosphate, vinylphosphonic acid and the like. Here, the counterion for forming the salt may be the counterion as mentioned above.

Further, the following monomers may be copolymerized.

1) An unsubstituted or substituted (meth)acrylamide, of which hydrogen atom on the nitrogen atom may be substituted by a saturated or unsaturated alkyl group having 1 to 4 carbon atoms or an aralkyl group. For instance, (meth)acrylamide, N-methyl(meth)acrylamide, N,N-dimethyl(meth)acrylamide, N-ethyl(meth)acrylamide, N-t-butyl (meth)acrylamide, (meth)acryloylmorpholine, 2-(N,N-dimethylamino)ethyl(meth)acrylamide, 3-(N,N-dimethylamino)propyl (meth)acrylamide, 2-hydroxyethyl(meth)acrylamide, N-methylol (meth)acrylamide, N-butoxymethyl(meth)acrylamide, and the like are preferable.

2) (Meth)acrylates. For instance, methyl(meth)acrylate, ethyl (meth)acrylate, 2-hydroxyethyl(meth)acrylate, 2-(N,N-dimethylamino)ethyl(meth)acrylate, 2-methoxyethyl(meth)acrylate, polyethylene glycol mono(meth)acrylates and the like are preferable.

In addition, the polymer having a sulfonic acid group and/or a sulfuric acid group in the present invention may be a cross-linked polymer, provided that the degree of cross-linking is preferably adjusted so that the gelation of the polymer is not generated. Specifically, the amount of the cross-linking agent used during the polymerization of the polymer is preferably from 0 to 0.001% by mole of the constituting monomers.

The cross-linking agent includes, for instance, (meth)acrylate compounds of polyhydric alcohols such as ethylene glycol di(meth)acrylate, diethylene glycol di(meth)acrylate, polyethylene glycol di(meth)acrylate, propylene glycol di(meth)acrylate, dipropylene glycol di(meth)acrylate, polypropylene glycol di(meth)acrylate, 1,2-butylene glycol di(meth)acrylate, 1,3-butylene glycol di(meth)acrylate, neopentyl glycol di(meth)acrylate, glycerol di(meth)acrylate, glycerol tri(meth)acrylate, trimethylolpropane tri(meth)acrylate, and pentaerythritol tetra(meth)acrylate; acrylamide compounds such as N-methylallylacrylamide, N-vinylacrylamide, N,N′-methylenebis(meth)acrylamide and bisacrylamideacetic acid; divinyl compounds such as divinylbenzene, divinyl ether, divinyl ethylene urea; polyallyl compounds such as diallyl phthalate, diallyl maleate, diallylamine, triallylamine, triallylammonium salt, allyl ether of pentaerythritol, allyl ether of sucrose having at least two allyl ether units in its molecule; esters of (meth)acrylic acid and unsaturated alcohols such as vinyl (meth)acrylate, allyl (meth)acrylate, and 2-hydroxy-3-acryloyloxypropyl (meth)acrylate; and the like.

Among these cross-linking agents, ethylene glycol di(meth)acrylate, polyethylene glycol di(meth)acrylate, divinylbenzene, pentaerythritol triallyl ether, and pentaerythritol tetraallyl ether are preferable.

In addition, besides the copolymerization with the above-mentioned cross-linkable monomer, the cross-linking may be carried out using the reaction with an epoxy compound such as 1,2-epoxybutane, 1,2-epoxyhexane, 1,2-epoxyoctane, or 1,2-epoxydecane. Alternatively, there may be carried out any of cross-linking methods such as covalent bonding cross-link according to such methods as self-cross-linking during the polymerization, a cross-linking reaction of the polymers with each other, or irradiation of radiation rays; ionic bonding cross-link via a metal ion or the like; cross-link via hydrogen bonding; cross-link by a partial crystalline structure; or cross-link ascribed to a helical structure.

In addition, in the case where the polymer having a sulfonic acid group and/or a sulfuric acid group in the present invention is a non-vinyl polymer, the non-vinyl polymer may be a polycondensed polymer such as a polyester, a polyamide, a polyurethane, or a polyimide, or a polyether polymer. Alternatively, a sulfonic acid group (and/or a salt form thereof) and/or a sulfuric acid group (and/or a salt form thereof) may be introduced in a ratio of 60% by mole or more of the constituting monomers into a known given polycondensed polymer or polyether polymer.

The polymer having a sulfonic acid group and/or a sulfuric acid group is considered to have a low affinity in a washing liquid to solid particles such as dirt or soot, and common dirt stain particles handled by detergents. For this reason, even when any of dirt and soot particles are present in the washing liquid, in the case where a high molecular weight polymer is present in a washing liquid in a concentration that is capable of exhibiting smoothness, the polymer does not cause aggregation due to simultaneous adsorption to a plurality of particles, so that the polymer is not likely to serve as a binder between the fibers and particles, whereby the phenomenon of redeposition of the dirt stains to laundry clothes is not likely to take place. Specifically, in the case where the spinnable organic polymer in the present invention is a polymer having a sulfonic acid group and/or a sulfuric acid group, the higher the molar ratio of these sulfonic acid monomers and sulfuric acid monomers to the monomers constituting the polymer, the more preferable.

The ratio of the constituting monomers having a sulfonic acid group (and/or a salt form thereof) or a sulfuric acid group (and/or a salt form thereof) is preferably 60% by mole or more, more preferably 66% by mole or more, even more preferably 85% by mole or more, and even more preferably 95% by mole or more of the entire constituting monomers.

As the polymer having a sulfonic acid group and/or a sulfuric acid group in the present invention, a molecule having an average molecular weight of 500,000 or more is used. The larger the average molecular weight, the intended “smoothness” can be realized in a smaller amount. As long as the polymer has an average molecular weight of 500,000 or more, the polymer can provide sufficient smoothness to clothes. The polymer has an average molecular weight of preferably 1,000,000 or more, more preferably 1,500,000 or more, even more preferably 2,000,000 or more, even more preferably 2,500,000 or more, even more preferably 3,000,000 or more, even more preferably 4,500,000 or more, even more preferably 5,000,000 or more, and even more preferably 6,000,000 or more, from the viewpoint of sufficiently realizing “smoothness” even at a dilute concentration during washing. On the other hand, the polymer has an average molecular weight of preferably 30,000,000 or less, and more preferably 20,000,000 or less, from the viewpoint of dissolubility.

In addition, in the properties of the polymer having a sulfonic acid group and/or a sulfuric acid group, the preferable properties for exhibiting “smoothness” is “spinnability.” The higher the spinnability of the polymer, the smaller the amount of the polymer formulated, so that “smoothness” can be realized. In the present invention, “high spinnability” means that an aqueous solution having a lower concentration or an aqueous solution having a low viscosity exhibits spinnability. The larger the molecular weight and lower cross-linking property of the linear polymer, the higher the spinnability, thereby exhibiting excellent “smoothness,” and is a preferable polymer in the present invention.

[Definition of Average Molecular Weight]

The average molecular weight of the organic polymer used in the present invention can be determined by the measurement of gel permeation chromatography (GPC) under the following conditions. Polyethylene oxide (PEO) whose molecular weight value reduced to as usual is used as a standard sample. Incidentally, in the present invention, the average molecular weight refers not to a number-average molecular weight or a weight-average molecular weight, but to a reduced value to PEO with the molecular weight of the fraction which offers the highest detection intensity in the GPC elution curve (hereinafter referred to as “peak-top molecular weight”). In other words, the phrase “organic polymer having an average molecular weight of 1,500,000 or more” refers to an organic polymer of which peak-top molecular weight is 1,500,000 or more in terms of the molecular weight reduced to PEO.

[Determination Conditions for GPC Method]

The column used is PW/GMPWXL/GMPWXL (manufactured by Tosoh Corporation), the eluent used is 0.2 M phosphate buffer (KH₂PO₄, Na₂HPO₄, pH=7)/CH₃CN=9/1 (weight ratio), the column temperature is 40° C., the flow rate is 1.0 mL/min, and the sample concentration is from 1 to 100 μg/mL. The detector used is RALLS (90° light scattering analyzer). Incidentally, the value for the average molecular weight can be estimated analysis using RID (differential diffractometer). The GPC analysis using RID is carried out under the conditions, for instance, that the column used is GMPWXL+GMPWXL, the eluent is 0.2 M phosphate buffer/CH₃CN=9/1 (weight ratio), the column temperature is 40° C., the flow rate is 0.5 mL/min, and the concentration is 0.05 mg/mL.

In addition, the present invention relates to an improver for exhibiting a smoothness improving effect of the present invention (hereinafter referred to as “the creamy smoothness improver of the present invention”), because the improver contains the spinnable organic polymer or the polymer having a sulfonic acid group and/or a sulfuric acid group mentioned above.

The form of the creamy smoothness improver of the present invention is not particularly limited, and any form of a powder, granule, liquid, slurry and paste can be used. Also, the creamy smoothness improver may be subjected to a secondary-molded process into an aggregate, a granule, a tablet or the like. These molding processes can be carried out by known processes.

The creamy smoothness improver of the present invention can surprisingly remarkably enhance its smoothening ability for clothes by adding the creamy smoothness improver to or dissolving the improver in water or other aqueous composition. Therefore, if the creamy smoothness improver of the present invention is added to a general detergent composition, the general detergent composition can be improved to provide the detergent composition of the present invention.

When the creamy smoothness improver of the present invention is added to a general detergent composition to provide the detergent composition of the present invention, the process for adding the creamy smoothness improver of the present invention is not particularly limited. In order to stably exhibit a sufficient effect as the creamy smoothness improver, the process for addition capable of homogeneously dispersing the creamy smoothness improver of the present invention in the detergent composition at a practical level is preferable in the preparation steps for the detergent composition. In an ordinary process for preparing a powder detergent, the creamy smoothness improver of the present invention may be added in the after-blended step (step of adding a detergent component, for instance, a fluorescer, an enzyme, a perfume, a defoaming agent, a bleaching agent, a bleaching activator or the like to a prepared detergent granule or the like). Alternatively, the creamy smoothness improver may be added in the surface-modifying step or the granulation step. If possible, the process for adding the creamy smoothness improver in the slurry formulation step may be conveniently employed.

It is preferable that the polymer having a sulfonic acid group and/or a sulfuric acid group is in the form of a powder or granule, because the polymer can be directly mixed with the detergent composition in the form of a powder or granule. The properties of the polymer particles are not particularly limited. The polymer particles have an average particle size of preferably 3 mm or less, more preferably 1 mm or less, and even more preferably 500 μm or less, from the viewpoint of dissolubility of the polymer particles. In addition, the polymer particles have an average particle size of preferably 10 μm or more, more preferably 50 μm or more, and even more preferably 100 μm or more, from the viewpoint of dispersibility when a detergent composition is supplied in water and prevention of formation of a doughy mass (a state where adhesion between the granules takes place by partially hydrating an aggregate of granules, so that the granules are not likely to be dispersed even when a mechanical force is applied). Although the process for preparing the polymer particles containing a sulfonic acid group and/or a sulfuric acid group is not particularly limited, the reverse phased suspension polymerization is preferable from the viewpoint of obtaining a powdery or granular polymer having the above-mentioned particle size.

In addition, in order that the spinnable organic polymer or the polymer containing a sulfonic acid group and/or a sulfuric acid group suppresses the generation of a doughy mass, the polymer can be used as a mixture of other base components by means such as granulation. The other base component as referred to herein may be any of those base components capable of sufficiently dispersing or dissolving the spinnable organic polymer or the polymer having a sulfonic acid group and/or a sulfuric acid group of the present invention. For instance, sodium sulfate, sodium carbonate, zeolite, polyethylene glycol, an alkyl sulfate or the like can be used in a proper amount.

The content of the spinnable organic polymer or the polymer having a sulfonic acid group and/or a sulfuric acid group is preferably an amount exceeding 0.1% by weight, more preferably an amount exceeding 0.2% by weight, more preferably an amount exceeding 0.25% by weight, more preferably 0.3% by weight or more, more preferably 0.5% by weight or more, even more preferably 1% by weight or more, and especially preferably 3% by weight or more, of the detergent composition, from the viewpoint of improving hand-washing smoothness. In addition, the content of the polymer is preferably 30% by weight or less, more preferably 20% by weight or less, and even more preferably 10% by weight or less, from the viewpoint of rinsability and powder properties.

Incidentally, in hand-washing, washing can be carried out under conditions where there is only a little amount of an item to be washed or a little amount of water. Therefore, as compared to the case where washing is carried out with a washing machine, the amount of the detergent composition used at once is more likely to be less. Especially in a powder detergent composition obtained by after-blending a composition containing the spinnable organic polymer or a composition containing the polymer having a sulfonic acid group and/or a sulfuric acid group in a powder state, the content of the spinnable organic polymer or the polymer having a sulfonic acid group and/or a sulfuric acid group used in a single washing is preferably an amount exceeding 0.1% by weight, more preferably an amount exceeding 0.2% by weight, more preferably an amount exceeding 0.25% by weight, more preferably 0.3% by weight or more, more preferably 0.5% by weight or more, more preferably 0.7% by weight or more, and especially preferably 1% by weight or more, of the detergent composition, from the viewpoint of homogeneously blending the spinnable organic polymer or the polymer having a sulfonic acid group and/or a sulfuric acid group contained in the detergent composition. In addition, the content of the polymer is preferably 20% by weight or less, more preferably 10% by weight or less, and even more preferably 5% by weight or less, from the viewpoint of compositional balance.

In addition, when the spinnable organic polymer of the present invention is used, in the case where the spinnable organic polymer is used in the form of a mixture with other components by means such as granulation, the dispersibility of the polymer in the composition becomes excellent by lowering the effective content of the spinnable organic polymer in one granule, from the viewpoint of stabilizing the amount of the spinnable organic polymer used.

5. Other Detergent Components

<(b) Surfactant>

As the surfactant usable in the present invention, any of conventionally known substances can be used. It is preferable that the surfactant contains an anionic surfactant or a nonionic surfactant as a main component from the viewpoint of enhancing detergency.

Especially, as the anionic surfactant, a salt of a linear alkylbenzenesulfonic acid of which alkyl moiety has 10 to 18 carbon atoms, a salt of a an alkyl sulfuric acid ester, a salt of a polyoxyalkylene alkyl ether sulfuric acid, a salt of a methyl ester of alpha-sulfofatty acid, an N-acyl amino acid-type surfactant, an alkyl or alkenyl ether carboxylate, an amino acid-type surfactant, an alkali metal salt such as an alkyl or alkenyl phosphate ester, or a salt thereof are preferable, and a salt of a fatty acid derived from beef tallow or coconut oil may be formulated therewith. Among them, the alkylbenzenesulfonate, the salt of the alkyl sulfuric acid ester, and the salt of the polyoxyalkylene alkyl ether sulfuric acid are preferable, and sodium alkylbenzenesulfonate is especially preferable. The anionic surfactant has an effect of further enhancing “spinnability” of the organic polymer defined in the present invention and “smoothness imparting effect” by the organic polymer. From this viewpoint, the content of the anionic surfactant is preferably 5% by weight or more, more preferably 10% by weight or more, more preferably 12% by weight or more, even more preferably 15% by weight or more, even more preferably 18% by weight or more, and even more preferably 20% by weight or more, of the detergent composition. In addition, the content of the anionic surfactant is preferably 40% by weight or less, more preferably 35% by weight or less, even more preferably 30% by weight or less, and even more preferably 26% by weight or less, of the detergent composition, from the viewpoint of powder properties.

In addition, as the nonionic surfactant, a polyoxyalkylene [preferably oxyethylene and/or oxypropylene] alkyl ether is preferable. Also, a polyoxyethylene alkyl phenyl ether, an alkanolamide of a higher fatty acid or an alkylene oxide adduct thereof, a sucrose fatty acid ester, an alkyl glycoside, or a fatty acid glycerol monoester can be used. The nonionic surfactant is outstandingly excellent in detergency against oily stains such as sebum dirt stains because of its excellent hard water resistance. The nonionic surfactant is used in an amount of 15% by weight or less, from the viewpoint of lathering ability and rinsability.

In addition, for the reasons given in the method of improving smoothness, when the spinnable organic polymer is a polyethylene oxide, it is preferable that the amount of formulation of polyoxyethylene alkyl ether is such that the composition essentially consists of no polyoxyethylene alkyl ether. The phrase “essentially consists of no polyoxyethylene alkyl ether” as used herein means that the compound is contained in an amount of less than 2%, more preferably less than 1.5%, more preferably less than 1%, more preferably less than 0.5%, and most preferably containing no amount. Even more preferably, the amount of formulation of the polyoxyalkylene alkyl ether and the polyoxyethylene alkyl phenyl ether is preferably less than 2%, more preferably less than 1.5%, more preferably less than 1%, more preferably less than 0.5%, and most preferably containing no amount.

The detergent composition of the present invention can be further formulated with a proper amount of a surfactant such as a betaine-type amphoteric surfactant, a phosphoric ester surfactant, a soap or a cationic surfactant.

<(c) Alkalizing Agent>

As the alkalizing agent usable in the present invention, it is preferable to formulate a conventionally known alkalizing agent. It is preferable to formulate the alkalizing agent in the detergent composition from the viewpoint of detergency. Examples of the alkalizing agent include alkali metal salts including alkali metal carbonates such as sodium carbonate collectively referred to as dense ash and light ash; amorphous alkali metal silicates, such as JIS No. 1, 2 or 3 Sodium Silicate; crystalline alkali metal silicates; and the like. The alkali metal salt has an effect of further enhancing “smoothness” by the organic polymer defined in the present invention. From this viewpoint, the content of the alkali metal salt is preferably 1% by weight or more, more preferably 5% by weight or more, more preferably 7% by weight or more, even more preferably 10% by weight or more, even more preferably 12% by weight or more, even more preferably 15% by weight or more, and even more preferably 20% by weight or more, of the detergent composition. In addition, the content of the alkalizing agent is preferably 40% or less, and more preferably 30% or less, of the detergent composition, from the viewpoint of compositional balance.

<(d) Metal Ion Capturing Agent>

It is very effective to formulate a metal ion capturing agent as a builder in the detergent composition to capture water hardness-increasing components in a washing water. In addition, the metal ion capturing agent has an effect of further enhancing “smoothness” by the polymer as defined in the present invention. Especially, it is more effective to formulate a metal ion capturing agent having a calcium ion capturing ability of 100 mg CaCO₃/g or more. The metal ion capturing agent includes a crystalline aluminosilicate, a crystalline sodium silicate, an acrylic acid polymer, an acrylic acid-maleic acid copolymer, sodium tripolyphosphate, ethylenediaminetetraacetic acid, and methylglycinediacetic acid. Here, in the present invention, sodium carbonate and amorphous sodium silicate are not included in the metal ion capturing agent. The content of the metal ion capturing agent is preferably 1% by weight or more, more preferably 5% by weight or more, even more preferably 10% by weight or more, and even more preferably 20% by weight or more, of the detergent composition, from the viewpoint of detergency. In addition, the content of the metal ion capturing agent is preferably 50% by weight or less, more preferably 40% by weight or less, and even more preferably 35% by weight or less, of the detergent composition, from the viewpoint of compositional balance.

<(e) Hydrogen Peroxide-Releasing Inorganic Salt>

In addition, the content of an inorganic salt capable of releasing hydrogen peroxide in water (hereinafter simply referred to as “hydrogen peroxide-releasing inorganic salt.”) is preferably 15% by weight or less, more preferably 10% by weight or less, even more preferably 5% by weight or less, and even more preferably 2.5% by weight or less, of the detergent composition, from the viewpoint of reducing a so-called “irritation against hand skin.”

The hydrogen peroxide-releasing inorganic salt is not particularly limited. The hydrogen peroxide-releasing inorganic salt includes, for instance, percarbonates, perborates, perphosphates, persilicates and the like.

<(f) Other Polymer>

In addition, the detergent composition of the present invention or the washing liquid usable in the present invention can contain, in addition to the organic polymer having spinnability, an organic polymer having a molecular weight of less than 500,000, and preferably a molecular weight of from 1,000 to 100,000, for the conventionally known purpose of increasing dispersibility of solid particle stains, including a carboxylate polymer, polyethylene glycol, carboxymethyl cellulose or the like.

<Carboxylate Polymer>

The carboxylate polymer has a function of dispersing the solid particle stains into a washtub besides the function of capturing metal ions. The carboxylate polymer is preferably a homopolymer or copolymer of acrylic acid, methacrylic acid, itaconic acid or the like. As the copolymer, those prepared by copolymerizing the above monomer with maleic acid are suitable, and those having a molecular weight of from 5,000 to 20,000 are preferable.

<Polyethylene Glycol>

The polyethylene glycol has a function of dispersing the solid particle stains into a washtub. A polyethylene glycol having a molecular weight of from 1,000 to 20,000 is preferable.

<Carboxymethyl Cellulose>

The carboxymethyl cellulose has a function of dispersing the solid particle stains into a washtub. It is preferable that a carboxymethyl cellulose has a molecular weight of from several thousands to several hundred thousands, and a degree of etherification thereof of from 0.2 to 1.0 from the viewpoint of dispersibility.

<(g) Other Additive>

The detergent composition of the present invention can contain a proper amount of an enzyme, a perfume, a fluorescer, a dye or the like.

6. Process for Washing

The present invention relates to a process for washing. One of the features of the process for washing of the present invention resides in that the process includes the step of washing an item to be washed with the detergent composition of the present invention, the detergent composition containing the spinnable organic polymer or the polymer having a sulfonic acid group and/or a sulfuric acid group of the present invention, or the detergent composition containing the creamy smoothness improver of the present invention. Since the process for washing has the above feature, smoothness is obtained between items to be washed, thereby exhibiting an effect of suppressing damage of fibers and the like of the item to be washed (a so-called laundry damage-care effect). In the hand-washing case, because of the improvement in feel, an effect is exhibited that hand-washing can be realized as a pleasant experience. Further, there is exhibited an effect of suppressing cuts, scratches and the like of hands generated by rubbing an item to be washed and hands with each other (a so-called abrasion reduction effect). Therefore, the smoothness improving effect of the present invention can be realized.

In the present invention, the larger the molecular weight of the spinnable organic polymer or the polymer having a sulfonic acid group and/or a sulfuric acid group in the present invention or the larger the content of the polymer in the washing liquid containing the polymer, the more improved the smoothness as well as the more improved the spinnability of the washing liquid. Therefore, the washing is realized as a more pleasant experience.

The washing liquid in the process for washing of the present invention may be the same as those mentioned above. In addition, in the process for washing of the present invention, the environment for carrying out washing, the kinds of items to be washed, the amount of an item to be washed, the water content, and further the size of a container in the case where washing is carried out in a container and the like are not particularly limited. The effects can be exhibited in all sorts of environments.

### EXAMPLES

The following examples further describe and demonstrate embodiments of the present invention. The examples are given solely for the purposes of illustration and are not to be construed as limitations of the present invention.

(Determination of Molecular Weight)

The molecular weight of each of the organic polymers used in the present Examples was determined according to the method described above. Here, RALLS was used as a detector.

Sample 1: Sodium polyacrylate “ARON A-20P” manufactured by TOAGOSEI CO., LTD.

Sample 2: Sodium salt of acrylamide methylpropanesulfonic acid/acrylic acid copolymer “ARON A-SOP” manufactured by TOAGOSEI CO., LTD.

Sample 3: Polyethylene oxide “PEO 8Z” manufactured by Sumitomo Seika Chemicals Company, Limited.

Sample 4 Polyethylene oxide “PEO 3Z” manufactured by Sumitomo Seika Chemicals Company, Limited.

Determination Results

Sample 1 (Peak): Average molecular weight: 5,000,000

Sample 2 (Peak): Average molecular weight: 5,500,000

Sample 3 (Peak): Average molecular weight: 2,800,000

Sample 4 (Peak): Average molecular weight: 1,200,000

Incidentally, the method for evaluating hand-washing carried out in the Examples will be described as follows.

<Method for Evaluating Hand-Washing>

[Conditions for Hand-Washing]

An 8.2 L polypropylene washtub (manufactured by YAZAKI) having a diameter of 30 cm and a depth of 13 cm was charged with 2 L of hard water (Ca/Mg molar ratio: 7/3) corresponding to 8.9 mg CaCO₃/liter, temperature-controlled to 25° C., and 15 g of a detergent composition was supplied into the water, and the water was continued to be stirred by hand with a vigorousness to an extent that the water was not spilled from the washtub. After 30 seconds from the beginning of stirring, a 100% cotton T-shirt (white, manufactured by Gunze, L size) was soaked in the washing liquid in the washtub so that the entire T-shirt was sufficiently soaked. Five minutes thereafter, the breast portions of the T-shirt were held with both hands, and the breast portions of the T-shirt were rubbed against each other. The portions were rubbed together upon taking the shirt out of the washing liquid. After rubbing together for every 3 to 5 times, the rubbed portions were temporarily soaked in the washing liquid. The ease in rubbing when the portions were rubbed together was judged in Ranks 1 to 5 as to smoothness. When this evaluation was carried out only with the water prepared above, the wrinkles of the T-shirt hindered the smoothness, the portions to be rubbed together were hardly rubbed because there were no bubbles in the portions rubbed together, so that the smoothness worsened. In such a case, the smoothness was defined to have a rank of 1. The state of each rank is as shown below.

Rank 1: very low smoothness and some feel of squeakiness, thereby making it very difficult to perform hand-washing.

Rank 2: low smoothness and some feel of squeakiness, thereby not being easy to perform hand-washing.

Rank 3: smoothness being medium level, and being capable of performing hand-washing without squeakiness.

Rank 4: smoothness being high, being capable of performing hand-washing more easily without squeakiness.

Rank 5: smoothness being very high, being capable of performing hand-washing very easily without squeakiness.

Incidentally, in the above test, an average value of the results of evaluation made by 6 expert panelists were obtained to provide the rank. Also, the evaluation of the smoothness-improving effect by a pair comparison with the detergent composition obtained in Preparation Example I-1 was carried out.

In addition, the spinnability of the washing liquid obtained in the above-mentioned method for evaluating hand-washing was evaluated according to the above-mentioned [Method for Judging Spinnability] by dissolving 15 g of a detergent composition in 86 ml of water.

<Test for Laundry Damage>

(Preparation of Pre-Treated Cloths)

With setting the washing water level of a fully automatic washing machine (Toshiba, “AW-D802VP”) to 45 L, the washing machine was charged with 10 pieces of Cotton T-shirts (about 2.2 kg). Further, a compact-type powder detergent (“ATTACK,” Kao Corporation) was supplied to the washing machine in accordance with a standard dosage, and a cycle of washing for 8 minutes, spin-drying for 3 minutes, rinsing in still water twice, and spin-drying for 3 minutes, and thereafter the T-shirts were dried with a drying machine. This washing cycle was repeated 5 times, to provide a pre-treated cloth.

(Test for Laundry Damage)

Four pieces out of the T-shirts obtained as the above pre-treated cloths were subjected to sewing with a sewing machine MA (Machine Action) test fabrics by Testfabrics, Inc. at a breast portion. The MA test fabrics as used herein were those described in Frants Szaras; “The mechanical action in washing machines. MA-test pieces instruction and application” (1982).

With setting the washing water level of a fully automatic washing machine (Toshiba, “AW-D802VP”) to 45 L, the washing machine was charged with 4 pieces of Cotton T-shirts sewed with the above MA test fabrics and 6 pieces of Cotton T-shirts without the above MA test fabrics being sewed thereto, a total of 10 pieces (about 2.2 kg). The amount of 67.5 g of the detergent composition was supplied to the washing machine, and soaking was carried out for 30 minutes and thereafter a washing cycle of washing for 8 minutes, spin-drying for 3 minutes, rinsing in still water twice, and spin-drying for 6 minutes was carried out, and thereafter the MA test fabrics were taken off from the T-shirts without drying. The number of frayed threads were counted.

(Method for Evaluation for Laundry Damage Test) The judgment was made by obtaining an average value of the frayed threads of the 4 pieces of the MA test fabrics.

<Preparation of Detergent Compositions>

### Preparation Example I-1

The amount of 325 kg of water, 200 kg of a 50% by weight aqueous sodium dodecylbenzenesulfonate solution, 75 kg of a 40% by weight aqueous No. 2 sodium silicate solution, 50 kg of sodium carbonate, 212.5 kg of sodium sulfate, 5 kg of polyethylene glycol, 2.5 kg of a CBS fluorescer, and 100 kg of zeolite were mixed together, to provide a homogeneous slurry. Thereafter, the obtained slurry was spray-dried, to provide a detergent composition.

### Comparative Example I-1

The smoothness of the detergent composition obtained in Preparation Example I-1 is shown in Table 1. The detergent composition had a smoothness rank of 2. Also, an aqueous solution prepared by dissolving the detergent composition did not exhibit spinnability.

### Preparation Example I-1

The amount of 325 kg of water, 240 kg of a 50% by weight aqueous sodium dodecylbenzenesulfonate solution, 6 kg of an alcohol ethoxylate (number of carbon atoms: 12, EO: 8 molar being added in average), 75 kg of a 40% by weight aqueous No. 2 sodium silicate solution, 50 kg of sodium carbonate, 186.5 kg of sodium sulfate, 5 kg of polyethylene glycol, 2.5 kg of a CBS fluorescer, and 100 kg of zeolite were mixed together, to provide a homogeneous slurry. Thereafter, the obtained slurry was spray-dried, to provide a detergent composition.

### Comparative Example I-2

The smoothness of the detergent composition obtained in Preparation Example I-2 is shown in Table 1. The detergent composition had a smoothness rank of 2. The detergent composition had the same level of smoothness as compared to that of Preparation Example I-1. Also, an aqueous solution prepared by dissolving the detergent composition did not exhibit spinnability.

### Preparation Example I-3

The amount of 465 kg of water, 48 kg of 50% by weight sodium dodecylbenzenesulfonate, 135 kg of a 40% by weight aqueous sodium polyacrylate solution, 120 kg of sodium carbonate, 60 kg of sodium sulfate, 9 kg of sodium sulfite, 3 kg of a CBS fluorescer, and 300 kg of zeolite were mixed together, to provide a homogeneous slurry. Thereafter, this slurry was spray-dried, to provide a base particle.

A mixed solution comprising 15 parts by weight of an alcohol ethoxylate (number of carbon atoms: 12, EO: 6 molar being added in average), 15 parts by weight of sodium alkylbenzenesulfonate, 1 part by weight of polyethylene glycol and 3 parts by weight of water was mixed together with 100 parts by weight of the base particle, while stirring, to provide a detergent composition.

### Comparative Example I-3

The smoothness of the detergent composition obtained in Preparation Example I-3 is shown in Table 1. This detergent composition had a smoothness rank of 2. The detergent composition had the same level of smoothness as compared to that of Preparation Example I-1. Also, an aqueous solution prepared by dissolving the detergent composition did not exhibit spinnability.

### Preparation Example I-4

The amount of 325 kg of water, 220 kg of a 50% by weight aqueous sodium dodecylbenzenesulfonate solution, 18 kg of an alcohol ethoxylate (number of carbon atoms: 12, EO: 6 molar being added in average), 75 kg of a 40% by weight aqueous No. 2 sodium silicate solution, 60 kg of sodium carbonate, 197.5 kg of sodium sulfate, 2.5 kg of a CBS fluorescer, and 93 kg of zeolite were mixed together, to provide a homogeneous slurry. Thereafter, the obtained slurry was spray-dried, to provide a detergent composition.

### Comparative Example I-4

The smoothness of the detergent composition obtained in Preparation Example I-4 is shown in Table 1. The detergent composition had a smoothness rank of 2. The detergent composition had the same level of smoothness as compared to that of Preparation Example I-1. Also, an aqueous solution prepared by dissolving the detergent composition did not exhibit spinnability.

### Comparative Example I-5

The amount of 4.0 kg of the detergent composition obtained in Preparation Example I-4 was supplied into a concrete mixer (manufactured by KYC Machine Industry CO., LTD., capacity: 40 L), and thereafter 50 g of polyethylene oxide having an average molecular weight of 2,800,000 (“PEO-8Z” manufactured by Sumitomo Seika Chemical Co., Ltd., with spinnability), 2 g of a fluorescer (“Tinopal CBS-X” manufactured by Ciba Geigy AG), and 12 g of perfume were added thereto. The components were mixed at a slanted angle of 30° at a rotational speed of 20 r/m for 3 minutes, to provide a detergent composition containing a high-molecular weight organic polymer. The smoothness of the detergent composition obtained is shown in Table 1. The detergent composition had a smoothness rank of 2. The detergent composition had the same level of smoothness as compared to that of Preparation Example I-1.

### Example I-1

The amount of 4.0 kg of the detergent composition obtained in Preparation Example I-1 was supplied into a concrete mixer (manufactured by KYC Machine Industry CO., LTD., capacity: 40 L), and thereafter 12 g of sodium polyacrylate having an average molecular weight of 5,000,000 (“ARON A-20P” manufactured by TOAGOSEI CO., LTD., with spinnability), 2 g of a DM fluorescer (“Tinopal DMA” manufactured by Ciba Geigy AG), and 12 g of perfume were added thereto. The components were mixed at a slanted angle of 30° at a rotational speed of 20 r/m for 3 minutes, to provide a detergent composition containing a high-molecular weight organic polymer. The washing water dissolving this detergent composition was viscous, and a lubricating layer containing the polymer could be felt on the surface of the T-shirts used. The smoothness of the detergent composition obtained is shown in Table 1. The detergent composition had a smoothness rank of 4. In comparison with that of Preparation Example I-1, almost all the panelists judged that the smoothness was clearly improved.

Also, an aqueous solution prepared by dissolving 15 g of the detergent composition in 86 ml of water exhibited spinnability.

### Example I-2

The amount of 4.0 kg of the detergent composition obtained in Preparation Example I-1 was supplied into a concrete mixer (manufactured by KYC Machine Industry CO., LTD., capacity: 40 L), and thereafter 20 g of sodium polyacrylate having an average molecular weight of 5,000,000 (“ARON A-20P” manufactured by TOAGOSEI CO., LTD., with spinnability), 200 g of carboxymethyl cellulose (“F10MC” manufactured by NIPPON PAPER CHEMICALS CO., LTD.), 84 g of a sodium percarbonate-containing granule (bleaching agent granule described in paragraph 0019 of JP-2000-256699 A), 4 g of cellulase (Cellzyme granules, manufactured by Novozymes) and 12 g of perfume were added thereto. The components were mixed at a slanted angle of 30° at a rotational speed of 20 r/m for 3 minutes, to provide a detergent composition containing a high-molecular weight organic polymer. The washing water dissolving this detergent composition was viscous, so that a lubricating layer containing the polymer could be clearly felt on the surface of the T-shirts used. The smoothness of the detergent composition obtained is shown in Table 1. The detergent composition had a smoothness rank of 5. In comparison with that of Preparation Example I-1, all members of the six panelists judged that the smoothness was clearly improved. Also, the aqueous solution prepared by dissolving 15 g of the detergent composition in 86 ml of water exhibited spinnability.

### Example I-3

The amount of 4.0 kg of the detergent composition obtained in Preparation Example I-3 was supplied into a concrete mixer (manufactured by KYC Machine Industry CO., LTD., capacity: 40 L), and thereafter 200 g of sodium polyacrylate having an average molecular weight of 3,000,000 (with spinnability), 160 g of carboxymethyl cellulose (“F10MC” manufactured by NIPPON PAPER CHEMICALS CO., LTD.), 8 g of protease (Kannase granules, manufactured by Novozymes), 4 g of a fluorescer (“Tinopal CBS-X” manufactured by Ciba Geigy AG), and 16 g of perfume were added thereto. The components were mixed at a slanted angle of 30° at a rotational speed of 20 r/m for 3 minutes, to provide a detergent composition containing a high-molecular weight organic polymer. The washing water dissolving this detergent composition is viscous, so that a lubricating layer containing the polymer could be felt on the surface of the T-shirts used. The smoothness of the detergent composition obtained is shown in Table 1. The detergent composition had a smoothness rank of 4. In comparison with that of Preparation Example I-1, almost all the panelists judged that the smoothness was clearly improved. Also, an aqueous solution prepared by dissolving 15 g of the detergent composition in 86 ml of water exhibited spinnability.

### Example I-4

The amount of 4.0 kg of the detergent composition obtained in Preparation Example I-3 was supplied into a concrete mixer (manufactured by KYC Machine Industry CO., LTD., capacity: 40 L), and thereafter 60 g of sodium acrylate/sodium acrylamide methylpropanesulfonate copolymer (AA/AMPS) having an average molecular weight of 5,000,000 (“ARON A-SOP” manufactured by TOAGOSEI CO., LTD., with spinnability), 120 g of carboxymethyl cellulose (“F10MC” manufactured by NIPPON PAPER CHEMICALS CO., LTD.), 4 g of cellulase (Cellzyme granules, manufactured by Novozymes), 8 g of protease (Kannase granules, manufactured by Novozymes), and 16 g of perfume were added thereto. The components were mixed at a slanted angle of 30° at a rotational speed of 20 r/m for 3 minutes, to provide a detergent composition containing a high-molecular weight organic polymer. The washing water dissolving this detergent composition was viscous, so that a lubricating layer containing the polymer could be clearly felt on the surface of the T-shirts used. The smoothness of the detergent composition obtained is shown in Table 1. The detergent composition had a smoothness rank of 5. In comparison with that of Preparation Example I-1, all members of the six panelists judged that the smoothness was clearly improved. Also, an aqueous solution prepared by dissolving 15 g of the detergent composition in 86 ml of water exhibited spinnability.

### Example I-5

The amount of 4.0 kg of the detergent composition obtained in Preparation Example I-1 was supplied into a concrete mixer (manufactured by KYC Machine Industry CO., LTD., capacity: 40 L), and thereafter 48 g of polyethylene oxide (PEO) having an average molecular weight of 2,800,000 (“PEO-8Z” manufactured by Sumitomo Seika Chemical Co., Ltd., with spinnability), 60 g of carboxymethyl cellulose (“F10MC” manufactured by NIPPON PAPER CHEMICALS CO., LTD.), 48 g of a sodium percarbonate-containing granule (bleaching agent granule described in paragraph 0019 of JP 2000-256699 A), 20 g of a sodium lauroyloxybenzenesulfonate granule (bleaching activator granule described in paragraph 0018 of JP 2000-256699 A), 8 g of cellulase (Cellzyme granules, manufactured by Novozymes), and 6 g of a fluorescer (“Tinopal CBS-X” manufactured by Ciba Geigy AG) were added thereto. The components were mixed at a slanted angle of 30° at a rotational speed of 20 r/m for 3 minutes, to provide a detergent composition containing a high-molecular weight organic polymer. The washing water dissolving this detergent composition was viscous, so that a lubricating layer containing the polymer could be clearly felt on the surface of the T-shirts used. The smoothness of the detergent composition obtained is shown in Table 1. The detergent composition had a smoothness rank of 5. In comparison with that of Preparation Example I-1, all members of the six panelists judged that the smoothness was clearly improved. Also, an aqueous solution prepared by dissolving 15 g of the detergent composition in 86 ml of water exhibited spinnability.

### Example I-6

The amount of 4.0 kg of the detergent composition obtained in Preparation Example I-1 was supplied into a concrete mixer (manufactured by KYC Machine Industry CO., LTD., capacity: 40 L), and thereafter 6.0 g of polyethylene oxide having an average molecular weight of 4,500,000 (“PEO-18Z” manufactured by Sumitomo Seika Chemical Co., Ltd., with spinnability), 2 g of a fluorescer (“Tinopal CBS-X” manufactured by Ciba Geigy AG), and 12 g of perfume were added thereto. The components were mixed at a slanted angle of 30° at a rotational speed of 20 r/m for 3 minutes, to provide a detergent composition containing a high-molecular weight organic polymer. The washing water dissolving this detergent composition was viscous, so that a lubricating layer containing the polymer could be clearly felt on the surface of the T-shirts used. The smoothness of the detergent composition obtained is shown in Table 1. The detergent composition had a smoothness rank of 5. In comparison with that of Preparation Example I-1, all members of the six panelists judged that the smoothness was clearly improved. Also, an aqueous solution prepared by dissolving 15 g of the detergent composition in 86 ml of water exhibited spinnability.

### Example I-7

The amount of 4.0 kg of the detergent composition obtained in Preparation Example I-2 was supplied into a concrete mixer (manufactured by KYC Machine Industry CO., LTD., capacity: 40 L), and thereafter 280 g of polyacrylamide having an average molecular weight of 5,000,000 (with spinnability), 80 g of carboxymethyl cellulose (“F10MC” manufactured by NIPPON PAPER CHEMICALS CO., LTD.), and 16 g of perfume were added thereto. The components were mixed at a slanted angle of 30° at a rotational speed of 20 r/m for 3 minutes, to provide a detergent composition containing a high-molecular weight organic polymer. The washing water dissolving this detergent composition was viscous, so that a lubricating layer containing the polymer could be clearly felt on the surface of the T-shirts used. The smoothness of the detergent composition obtained is shown in Table 1. The detergent composition had a smoothness rank of 4. In comparison with that of Preparation Example I-1, almost all the panelists judged that the smoothness was clearly improved. Also, an aqueous solution prepared by dissolving 15 g of the detergent composition in 86 ml of water exhibited spinnability.

Here, when the hand-washing was carried out in Examples I-1 to I-7, chapping on hands, and damage of fibers were not generated. The above-mentioned test for laundry damage was carried out using the detergent compositions obtained in Preparation Example I-1 and Example I-6. The number of frayed threads (average value of 4 pieces of MA test cloths) for each detergent composition was 86 and 70, respectively.

TABLE 1

| | Comp. | Comp. | Comp. | Comp. | Comp. | | | | | | | |
|---|---|---|---|---|---|---|---|---|---|---|---|---|
| | Ex. I-1 | Ex. I-2 | Ex. I-3 | Ex. I-4 | Ex. I-5 | Ex. I-1 | Ex. I-2 | Ex. I-3 | Ex. I-4 | Ex. I-5 | Ex. I-6 | Ex. I-7 |
| Base Detergent | | | | | | | | | | | | |
| Prep. Ex. I-1 | 100.0 | | | | | 100.0 | 100.0 | | | 100.0 | 100.0 | |
| Prep. Ex. I-2 | | 100.0 | | | | | | | | | | 100.0 |
| Prep. Ex. I-3 | | | 100.0 | | | | | 100.0 | 100.0 | | | |
| Prep. Ex. I-4 | | | | 100.0 | 100.0 | | | | | | | |
| Other Ingredients | | | | | | | | | | | | |
| Carboxymethyl | | | | | | | 5.0 | 4.0 | 3.0 | 1.5 | | 2.0 |
| Cellulose (CMC) | | | | | | | | | | | | |
| Cellulase | | | | | | | 0.1 | | 0.1 | 0.2 | | |
| Protease | | | | | | | | 0.2 | 0.2 | | | |
| Sodium Percarbonate | | | | | | | 2.1 | | | 1.2 | | 1.4 |
| Granule | | | | | | | | | | | | |
| Sodium Lauroyloxy- | | | | | | | | | | 0.5 | | |
| benzenesulfonate | | | | | | | | | | | | |
| Granule | | | | | | | | | | | | |
| Perfume | | | | | 0.3 | 0.3 | 0.3 | 0.4 | 0.4 | | 0.3 | 0.4 |
| Spinnable Organic | | | | | | | | | | | | |
| Polymer | | | | | | | | | | | | |
| Sodium Polyacrylate | | | | | | | | 5.0 | | | | |
| (MW 3,000,000) | | | | | | | | | | | | |
| Sodium Polycrylate | | | | | | 0.3 | 0.5 | | | | | |
| (MW 5,000,000) | | | | | | | | | | | | |
| AA/AMPS | | | | | | | | | 1.2 | | | |
| (MW 5,000,000) | | | | | | | | | | | | |
| PEO (MW 2,800,000) | | | | | 1.25 | | | | | 1.5 | | |
| PEO (MW 4,500,000) | | | | | | | | | | | 0.15 | |
| Polyacrylamide | | | | | | | | | | | | 7.0 |
| (MW 5,000,000) | | | | | | | | | | | | |
| Rank for Smoothness | 2 | 2 | 2 | 2 | 2 | 4 | 5 | 4 | 5 | 5 | 5 | 4 |

In the table, numerical values for each component are expressed by parts by weight, and MW stands for an average molecular weight.

<Preparation of Sulfonate Group-Containing and/or Sulfate Group-Containing Polymer>

### Synthesis Example II-1

### Synthesis Example of Polymer 1 [Homopolymer of Sodium 2-Acrylamide-2-methylpropanesulfonate]

A solution prepared by dissolving 50.3 g of sodium 2-acrylamide-2-methylpropanesulfonate, 32.4 g of sodium hydroxide, and 3.95 g of 2,2′-azobis(2-methylpropionamidine)dihydrochloride (“V-50,” manufactured by Wako Pure Chemical Industries, Ltd.) in 135 g of ion-exchanged water was heated to a temperature of 50° C. under a nitrogen atmosphere, and the mixture was stirred for 1 hour. Thereafter, the temperature was increased to 70° C., and the mixture was stirred for an additional 8 hours. The resulting mixture was diluted with 360 g of ion-exchanged water, and thereafter, 2700 g of ethanol was added thereto to precipitate a solid polymer. The precipitated polymer was dried under reduced pressure, to provide 55.0 g of a colorless solid polymer (yield: 98.8%). The resulting polymer was subjected to GPC determination. As a result, a peak top molecular weight (reduced to polyethylene glycol (PEO), column: GMPWXL+GMPWXL, developing solvent: 0.2 M phosphate buffer/CH₃CN=9/1 (weight ratio), concentration: 0.05 mg/mL, flow rate: 0.5 mL/min, 40° C., detector: RALLS, determination of an average molecular weight under the same conditions hereinafter the same) was 2,000,000.

### Synthesis Example II-2

### Synthesis Example of Polymer 2 [Homopolymer of Sodium 2-Acrylamide-2-methylpropanesulfonate]

A solution prepared by dissolving 20.0 g of sodium 2-acrylamide-2-methylpropanesulfonate, 3.86 g of sodium hydroxide, and 0.055 g of ammonium persulfate in 50 g of ion-exchanged water was dispersed in a solution prepared by dissolving 1.00 g of a sugar ester (“S-770,” Mitsubishi Chemical Foods K.K.) in 185 g of n-hexane. The dispersion was heated to a temperature of 60° C. under a nitrogen atmosphere, and the mixture was stirred for 3 hours. The water content was reduced by removing only the aqueous phase from the azeotropically refluxing solution until the water content to the polymer reached 30% by weight, and the reaction mixture was allowed to air-cool. The resulting solid granular product was dried under reduced pressure, to provide 22.0 g of a colorless granular polymer (yield: 99.1%). The resulting polymer was subjected to GPC determination. As a result, the peak top molecular weight was 3,000,000. The average particle size of the polymer was 230 μm.

Here, the average particle size of the polymer was determined using sieves as prescribed according to JIS Z 8801. Ten-step sieves each having a sieve-opening of 2,000 μm, 1,400 μm, 1,000 μm, 710 μm, 500 μm, 355 μm, 250 μm, 180 μm, 125 μm, and 106 μm, and a receiving tray were used, and the sieves and the receiving tray were attached to a rotating and tapping shaker machine (manufactured by HEIKO SEISAKUSHO). A 100 g sample was vibrated for 10 minutes to be classified (tapping: 156 times/min, rolling: 290 times/min). Thereafter, the weight of the granules remaining on the receiving tray, and each of the sieves was determined. When a sieve-opening of a first sieve of which cumulative weight ratio counted from fine particle side is 50% or more is defined as a μm, a sieve-opening of one step larger than a μm is defined as b μm, a cumulative weight ratio from the receiving tray to the a μm-sieve is defined as c %, and a mass weight ratio on the a μm-sieve is defined as d %, the average particle size can be calculated according to the following formula:
(Average Particle Size)=10^{A}
wherein A satisfies the formula:
A=(50−(c−d/(log b−log a)×log b))/(d/(log b−log a)).

### Synthesis Example II-3

### Synthesis Example of Polymer 3 [Homopolymer of Sodium 2-Acrylamide-2-methylpropanesulfonate]

To a solution prepared by dissolving 6.00 g of a sugar ester (“S-770,” Mitsubishi Chemical Foods K.K.) in 950 g of n-hexane, and refluxing the solution under a nitrogen atmosphere was added dropwise over a period of 1 hour a solution prepared by dissolving 665 g of sodium 2-acrylamide-2-methylpropanesulfonate and 0.80 g of 2,2′-azobis(2-methylpropionamidine)dihydrochloride (“V-50,” manufactured by Wako Pure Chemical Industries, Ltd.) in 590 g of ion-exchanged water, and dispersed, and the mixture was stirred for an additional 30 minutes. The mixture obtained was subjected to azeotropic dehydration and drying in the same manner as in Synthesis Example II-2, to thereafter provide 664 g of a colorless granular polymer (yield: 99.8%). The resulting polymer was subjected to GPC determination. As a result, the peak top molecular weight was 6,200,000. The average particle size of the polymer was 250 μm. In addition, spinnability was found in a 0.4% by weight aqueous solution of the polymer.

### Synthesis Example II-4

### Synthesis Example of Polymer 4 [Copolymer of Sodium 2-Acrylamide-2-methylpropanesulfonate/Sodium Acrylate=95:5 (Molar Ratio)]

To a solution prepared by dissolving 6.00 g of a sugar ester (“S-770,” Mitsubishi Chemical Foods K.K.) in 800 g of cyclohexane, and heating the solution to a temperature of 70° C. under a nitrogen atmosphere was added dropwise over a period of 1 hour a solution prepared by dissolving 600 g of 2-acrylamide-2-methylpropanesulfonic acid, 160 g of sodium hydroxide, 10 g of acrylic acid, and 2.40 g of 2,2′-azobis(2-methylpropionamidine)dihydrochloride (“V-50,” manufactured by Wako Pure Chemical Industries, Ltd.) in 510 g of ion-exchanged water, and dispersed, and the mixture was stirred for an additional 30 minutes. The mixture obtained was subjected to azeotropic dehydration and drying in the same manner as in Synthesis Example II-2, to provide 672 g of a colorless granular polymer (99.4%). The resulting polymer was subjected to GPC determination. As a result, the peak top molecular weight was 4,500,000. The average particle size of the polymer was 150 μm. In addition, spinnability was found in a 0.5% by weight aqueous solution of the polymer.

### Synthesis Example II-5

### Synthesis Example of Polymer 5 [Copolymer of Sodium 2-Acrylamide-2-methylpropanesulfonate/Sodium Acrylate=95:5 (Molar Ratio)]

To a solution prepared by dissolving 6.00 g of a sugar ester (“S-770,” Mitsubishi Chemical Foods K.K.) in 800 g of n-hexane, and refluxing the solution under a nitrogen atmosphere was added dropwise over a period of 1 hour a solution prepared by dissolving 600 g of 2-acrylamide-2-methylpropanesulfonic acid, 160 g of sodium hydroxide, 10 g of acrylic acid, and 0.80 g of 2,2′-azobis(2-methylpropionamidine) dihydrochloride (“V-50,” manufactured by Wako Pure Chemical Industries, Ltd.) in 510 g of ion-exchanged water, and dispersed while keeping the mixture at a temperature of 10° C. or less, and the mixture was stirred for an additional 30 minutes. The mixture obtained was subjected to azeotropic dehydration and drying in the same manner as in Synthesis Example II-2, to thereafter provide 674 g of a colorless granular polymer (99.7%). The resulting polymer was subjected to GPC determination. As a result, the peak top molecular weight was 7,800,000. The average particle size of the polymer was 220 μm. In addition, spinnability was found in a 0.3% by weight aqueous solution of the polymer.

### Synthesis Example II-6

### Synthesis Example of Polymer 6 [Cross-Linked Polymer of Sodium 2-Acrylamide-2-methylpropanesulfonate]

To a solution prepared by dissolving 2.00 g of a sugar ester (“S-770,” Mitsubishi Chemical Foods K.K.) in 950 g of n-hexane, and refluxing the solution under a nitrogen atmosphere was added dropwise over a period of 1 hour a solution prepared by dissolving 440 g of sodium 2-acrylamide-2-methylpropanesulfonate, 0.011 g of polyethylene glycol dimethacrylate (“NK ESTER 23G,” manufactured by Shin-Nakamura Chemical Co., Ltd.), and 0.50 g of 2,2′-azobis(2-methylpropionamidine)dihydrochloride (“V-50,” manufactured by Wako Pure Chemical Industries, Ltd.) in 390 g of ion-exchanged water, and dispersed, and the mixture was stirred for an additional 30 minutes. The mixture obtained was subjected to azeotropic dehydration and drying in the same manner as in Synthesis Example II-2, to provide 438 g of a colorless granular polymer (yield: 99.5%). The resulting polymer was subjected to GPC determination. As a result, the peak top molecular weight was 5,000,000. The average particle size of the polymer was 200 μm. In addition, spinnability was found in a 0.5% by weight aqueous solution of the polymer.

<Preparation of Detergent Compositions>

### Preparation Example II-1

The amount of 325 kg of water, 200 kg of a 50% by weight aqueous sodium dodecylbenzenesulfonate solution, 125 kg of a 40% by weight aqueous No. 2 sodium silicate solution, 50 kg of sodium carbonate, 50 kg of sodium tripolyphosphate, 150 kg of sodium sulfate, 5 kg of polyethylene glycol, 6.25 kg of a 40% by weight aqueous solution of acrylic acid/maleic acid copolymer, 2.5 kg of a CBS fluorescer, and 100 kg of zeolite were mixed together, to provide a homogeneous slurry. Thereafter, the obtained slurry was spray-dried, to provide a detergent composition. The properties of the resulting detergent composition were evaluated in accordance with the following methods.

<Method for Evaluating Hand-Washing>

A test was conducted in the same manner as above, and an average value of the results of evaluation made by 6 expert panelists were obtained to provide the rank. Here, 2 L of hard water equivalent to 89 mg CaCO₃/L (Ca/Mg molar ratio: 7/3) was used. The evaluation of the smoothness-improving effect was carried out using the detergent composition obtained in Preparation Example II-1 as the subject to be compared in a pair comparison.

<Method for Evaluating Laundry Damage>

A test was conducted in the same manner as above, and an average value of 4 pieces of MA test cloths was obtained.

<Method for Evaluating Carbon Stain Redeposition Preventing Property>

The amount of 5.0 g of a detergent composition was dissolved in 1000 mL of water used (CaCl₂: 55.42 mg/L, MgCl₂·6H₂O: 43.51 mg/L) at 40° C. Next, 0.25 g of carbon black selected by Nippon Yukagaku Kyokai (manufactured by Asahi Carbon K.K., preferably Asahi carbon black for washing) was added thereto. The mixture was irradiated with ultrasonication at 26±1.5 kHz for 5 minutes to homogeneously disperse the carbon black. Next, the dispersion was transferred to a sample cup attached to a mixing type detergency tester (Terg-O-Tometer) at 20° C. Five pieces of cotton calico of 6 cm×6 cm (#2023 calico, standard product selected by Nippon Yukagaku Kyokai, sold by Sentaku Kagaku Kyokai) were introduced into the detergency tester, and agitated at a rotational speed of 100±5 r/m for 10 minutes. Next, the cotton calico that was taken out from the detergency tester was lightly hand-squeezed so as to have a water content of 200% by weight or less. The calico was placed in 1,000 mL of water used (CaCl₂: 55.42 mg/L, MgCl₂·6H₂O: 43.51 mg/L) at 40° C., and rinsed for 3 minutes with the mixing type detergency tester (rotational speed: 100±5 r/m) for 3 minutes. The rinsing procedures were carried out for a total of 2 times. Next, the calico that was taken out was air-dried, and thereafter finished by ironing. Thereafter, the reflectance of the obtained cloth at 550 nm was determined (spectrophotometer, manufactured by Nihon Denshoku Kogyo K.K.). The redeposition preventing ratio was obtained by the following formula, and evaluated in accordance with the following evaluation criteria.

$$\begin{matrix}Redeposition \\ Preventing Ratio \\ ( \% )\end{matrix} = \frac{( Reflectance of Cotton Calico After Test )}{( Reflectance of Cotton Calico Before Test )} \times 100$$

Evaluation Criteria:
O: Redeposition preventing ratio being 60% or more; and
X: Redeposition preventing ratio being less than 60%.

<Method for Evaluating Dirt Stain Redeposition Preventing Property>

The amount of 5.0 g of a detergent composition was dissolved in 1,000 mL of water used (CaCl₂: 55.42 mg/L, MgCl₂·6H₂O: 43.51 mg/L) at 40° C. Next, 2.5 g of dirt (Kanuma red clay for gardening, having a size of passing a sieve opening of 200 mesh [purchased from K.K. Kokukoen (10, Yoshimasa-cho, Izumi-shi, Osaka)] was added thereto, and the mixture was homogeneously dispersed. Next, the dispersion was transferred to a sample cup attached to a mixing type detergency tester (Terg-O-Tometer). Five pieces of cotton calico of 6 cm×6 cm (#2023 calico, standard product selected by Nippon Yukagaku Kyokai, sold by Sentaku Kagaku Kyokai) were introduced into the detergency tester, and agitated at a rotational speed of 100±5 r/m for 10 minutes. Next, the cotton calico that was taken out was lightly hand-squeezed so as to have a water content of 200% by weight or less. The calico was placed in 1,000 mL of water used (CaCl₂: 55.42 mg/L, MgCl₂·6H₂O: 43.51 mg/L) at 40° C., and rinsed for 3 minutes with the mixing type detergency tester (rotational speed: 100±5 r/m) for 3 minutes. The rinsing procedures were carried out for a total of 2 times. Next, the calico that was taken out was air-dried, and thereafter finished by ironing. Thereafter, the reflectance of the obtained cloth at 460 nm was determined (spectrophotometer, manufactured by Nihon Denshoku Kogyo K.K.). The redeposition preventing ratio was obtained by the following formula, and evaluated in accordance with the following evaluation criteria.

$$\begin{matrix}Redeposition \\ Preventing Ratio \\ ( \% )\end{matrix} = \frac{( Reflectance of Cotton Calico After Test )}{( Reflectance of Cotton Calico Before Test )} \times 100$$

Evaluation Criteria:
O: Redeposition preventing ratio being 66% or more; and
X: Redeposition preventing ratio being less than 66%.

### Comparative Example II-1

Smoothness and redeposition preventing properties of the detergent composition obtained in Preparation Example II-1 are shown in Table 2. The detergent composition showed a rank for smoothness of 2, having the smoothness at the same level as compared to that of Preparation Example II-1. Also, the detergent composition had a carbon stain redeposition preventing property of O, and dirt stain redeposition preventing property of O.

### Preparation Example II-2

The amount of 325 kg of water, 240 kg of a 50% by weight aqueous sodium dodecylbenzenesulfonate solution, 6 kg of an alcohol ethoxylate (number of carbon atoms: 12, EO: 8 molar being added in average), 75 kg of a 40% by weight aqueous No. 2 sodium silicate solution, 50 kg of sodium carbonate, 186.5 kg of sodium sulfate, 5 kg of polyethylene glycol, 2.5 kg of a CBS fluorescer, and 100 kg of zeolite were mixed together, to provide a homogeneous slurry. Thereafter, the obtained slurry was spray-dried, to provide a detergent composition.

### Comparative Example II-2

Smoothness and redeposition preventing properties of the detergent composition obtained in Preparation Example II-2 are shown in Table 2. The detergent composition showed a rank for smoothness of 2 having the smoothness at the same level as compared to that of Preparation Example II-1. Also, the detergent composition had a carbon stain redeposition preventing property of O, and dirt stain redeposition preventing property of O.

### Preparation Example II-3

The amount of 465 kg of water, 48 kg of a 50% aqueous sodium dodecylbenzenesulfonate solution, 135 kg of a 40% by weight aqueous sodium polyacrylate solution, 120 kg of sodium carbonate, 60 kg of sodium sulfate, 9 kg of sodium sulfite, 3 kg of a CBS fluorescer, and 300 kg of zeolite were mixed together, to provide a homogeneous slurry. Thereafter, this slurry was spray-dried, to provide a base particle.

A mixed solution comprising 15 parts by weight of an alcohol ethoxylate (number of carbon atoms: 12, EO: 6 molar being added in average), 15 parts by weight of sodium alkylbenzenesulfonate, 1 part by weight of polyethylene glycol, and 3 parts by weight of water was mixed together with 100 parts by weight of the base particle, while stirring, to provide a detergent composition.

### Comparative Example II-3

Smoothness and redeposition preventing properties of the detergent composition obtained in Preparation Example II-3 are shown in Table 2. The resulting detergent composition showed a rank for smoothness of 2 having the smoothness at the same level as compared to that of Preparation Example II-1. Also, the detergent composition had a carbon stain redeposition preventing property of O, and dirt stain redeposition preventing property of O.

### Example II-1

The amount of 4.0 kg of the detergent composition obtained in Preparation Example II-2 was supplied into a concrete mixer (manufactured by KYC Machine Industry CO., LTD., capacity: 40 L), and thereafter 720 g of the polymer 1 of Synthesis Example II-1, 2 g of a DM fluorescer (“Tinopal DMA” manufactured by Ciba Geigy AG), and 12 g of perfume were added thereto. The components were mixed at a slanted angle of 30° at a rotational speed of 20 r/m for 3 minutes, to provide a detergent composition. Smoothness and redeposition preventing properties of the resulting detergent composition are shown in Table 2. The resulting detergent composition showed a rank for smoothness of 4, so that in comparison with that of Preparation Example I-1, almost all the panelists judged that the smoothness was clearly improved. Also, the detergent composition had a carbon stain redeposition preventing property of O, and dirt stain redeposition preventing property of O.

### Example II-2

The amount of 4.0 kg of the detergent composition obtained in Preparation Example II-3 was supplied into a concrete mixer (manufactured by KYC Machine Industry CO., LTD., capacity: 40 L), and thereafter 360 g of the polymer 2 obtained in Synthesis Example II-2, 200 g of carboxymethyl cellulose (“F10MC” manufactured by NIPPON PAPER CHEMICALS CO., LTD.), 84 g of a sodium percarbonate-containing granule (bleaching agent granule described in paragraph 0019 of JP-2000-256699 A), 4 g of cellulase (Cellzyme granules, manufactured by Novozymes) and 12 g of perfume were added thereto. The components were mixed at a slanted angle of 30° at a rotational speed of 20 r/m for 3 minutes, to provide a detergent composition. Smoothness and redeposition preventing properties of the resulting detergent composition are shown in Table 2. The resulting detergent composition showed a rank for smoothness of 4, so that in comparison with that of Preparation Example II-1, almost all the panelists judged that the smoothness was clearly improved. Also, the detergent composition had a carbon stain redeposition preventing property of O, and dirt stain redeposition preventing property of O.

### Example II-3

The amount of 4.0 kg of the detergent composition obtained in Preparation Example II-1 was supplied into a concrete mixer (manufactured by KYC Machine Industry CO., LTD., capacity: 40 L), and thereafter 120 g of the polymer 3 obtained in Synthesis Example II-3, 160 g of carboxymethyl cellulose (“F10MC” manufactured by NIPPON PAPER CHEMICALS CO., LTD.), 8 g of protease (Kannase granules, manufactured by Novozymes), 4 g of a fluorescer (“Tinopal CBS-X” manufactured by Ciba Geigy AG), and 16 g of perfume were added thereto. The components were mixed at a slanted angle of 30° at a rotational speed of 20 r/m for 3 minutes, to provide a detergent composition. Smoothness and redeposition preventing properties of the resulting detergent composition are shown in Table 2. The resulting detergent composition showed a rank for smoothness of 5, so that in comparison with that of Preparation Example II-1, all members of the six panelists judged that the smoothness was clearly improved. Also, the detergent composition had a carbon stain redeposition preventing property of O, and dirt stain redeposition preventing property of O.

### Example II-4

The amount of 4.0 kg of the detergent composition obtained in Preparation Example II-2 was supplied into a concrete mixer (manufactured by KYC Machine Industry CO., LTD., capacity: 40 L), and thereafter 320 g of the polymer 4 obtained in Synthesis Example II-4, 48 g of a sodium percarbonate-containing granule (bleaching agent granule described in paragraph 0019 of JP 2000-256699 A), 20 g of a sodium lauroyloxybenzenesulfonate granule (bleaching activator granule described in paragraph 0018 of JP 2000-256699 A), 120 g of carboxymethyl cellulose (“F10MC” manufactured by NIPPON PAPER CHEMICALS CO., LTD.), 4 g of cellulase (Cellzyme granules, manufactured by Novozymes), 8 g of protease (Kannase granules, manufactured by Novozymes), and 16 g of perfume were added thereto. The components were mixed at a slanted angle of 30° at a rotational speed of 20 r/m for 3 minutes, to provide a detergent composition. Smoothness and redeposition preventing properties of the resulting detergent composition are shown in Table 2. The resulting detergent composition showed a rank for smoothness of 5, so that in comparison with that of Preparation Example II-1, all members of the six panelists judged that the smoothness was clearly improved. Also, the detergent composition had a carbon stain redeposition preventing property of O, and dirt stain redeposition preventing property of O.

### Example II-5

The amount of 4.0 kg of the detergent composition obtained in Preparation Example II-1 was supplied into a concrete mixer (manufactured by KYC Machine Industry CO., LTD., capacity: 40 L), and thereafter 60 g of the polymer 5 obtained in Synthesis Example II-5, 8 g of cellulase (Cellzyme granules, manufactured by Novozymes), 6 g of a fluorescer (“Tinopal CBS-X” manufactured by Ciba Geigy AG), and 12 g of perfume were added thereto. The components were mixed at a slanted angle of 30° at a rotational speed of 20 r/m for 3 minutes, to provide a detergent composition. Smoothness and redeposition preventing properties of the resulting detergent composition are shown in Table 2. The resulting detergent composition showed a rank for smoothness of 5, so that in comparison with that of Preparation Example II-1, all members of the six panelists judged that the smoothness was clearly improved. Also, the detergent composition had a carbon stain redeposition preventing property of O, and dirt stain redeposition preventing property of O.

### Example II-6

The amount of 4.0 kg of the detergent composition obtained in Preparation Example II-1 was supplied into a concrete mixer (manufactured by KYC Machine Industry CO., LTD., capacity: 40 L), and thereafter 160 g of the polymer 6 obtained in Synthesis Example II-6 and 12 g of perfume were added thereto. The components were mixed at a slanted angle of 30° at a rotational speed of 20 r/m for 3 minutes, to provide a detergent composition. Smoothness and redeposition preventing properties of the resulting detergent composition are shown in Table 2. The resulting detergent composition showed a rank for smoothness of 5, so that in comparison with that of Preparation Example II-1, all members of the six panelists judged that the smoothness was clearly improved. Also, the detergent composition had a carbon stain redeposition preventing property of O, and dirt stain redeposition preventing property of O.

When washing was carried out using each of the detergent compositions obtained in Examples II-1 to II-6, there was a remarkable difference such that the reduction in unpleasant factors such as “rough texture” or “squeakiness” and physical fatigues could be significantly felt, as compared to those of Comparative Examples II-1 to II-3. In addition, when washing was carried out using each of the detergent compositions obtained in Examples II-1 to II-6, chapping was not generated on hands, and loss of well kept shape and the like were not generated on the laundry.

The above-mentioned test for laundry damage was carried out using the detergent compositions obtained in Preparation Example II-1 and Example II-5. The number of frayed threads (average value of 4 pieces of MA test cloths) for each detergent composition was 88 and 72, respectively.

TABLE 2

| | Comp. | Comp. | Comp. | | | | | | |
|---|---|---|---|---|---|---|---|---|---|
| | Ex. II-1 | Ex. II-2 | Ex.II-3 | Ex. II-1 | Ex. II-2 | Ex. II-3 | Ex. II-4 | Ex. II-5 | Ex. II-6 |
| Components of Detergent Composition | | | | | | | | | |
| (parts by weight) | | | | | | | | | |
| Base Detergent | | | | | | | | | |
| Prep. Ex. II-1 | 100.0 | | | | | 100.0 | | 100.0 | 100.0 |
| Prep. Ex. II-2 | | 100.0 | | 100.0 | | | 100.0 | | |
| Prep. Ex. II-3 | | | 100.0 | | 100.0 | | | | |
| Other Components | | | | | | | | | |
| Carboxymethyl Cellulose (CMC) | | | | | 5.0 | 4.0 | 3.0 | | |
| Cellulase | | | | | 0.1 | | 0.1 | 0.2 | |
| Protease | | | | | | 0.2 | 0.2 | | |
| Sodium Percarbonate-Containing Granule | | | | | 2.1 | | 1.2 | | |
| Sodium Lauroyloxybenzenesulfonate Granule | | | | | | | 0.5 | | |
| Fluorescer | | | | 0.05 | | 0.1 | | 0.15 | |
| Perfume | | | | 0.3 | 0.3 | 0.4 | 0.4 | 0.3 | 0.3 |
| Polymer | | | | | | | | | |
| Synthesis Polymer 1 AMPS (MW 2,000,000) | | | | 18.0 | | | | | |
| Synthesis Polymer 2 AMPS (MW 3,000,000) | | | | | 9.0 | | | | |
| Synthesis Polymer 3 AMPS (MW 6,200,000) | | | | | | 3.0 | | | |
| Synthesis Polymer 4 AMPS/AA (MW 4,500,000) | | | | | | | 8.0 | | |
| Synthesis Polymer 5 AMPS/AA (MW 7,800,000) | | | | | | | | 1.5 | |
| Synthesis Polymer 6 Cross-Linked (MW 5,000,000) | | | | | | | | | 4.0 |
| Rank for Smoothness | 2 | 2 | 2 | 4 | 4 | 5 | 5 | 5 | 5 |
| Redeposition Preventing Property | | | | | | | | | |
| Carbon Stain Redeposition Preventing Property | ◯ | ◯ | ◯ | ◯ | ◯ | ◯ | ◯ | ◯ | ◯ |
| Dirt Stain Redeposition Preventing Property | ◯ | ◯ | ◯ | ◯ | ◯ | ◯ | ◯ | ◯ | ◯ |

Note:
MW stands for average molecular weight.

In the table, AMPS stands for sodium 2-acrylamide-2-methylpropanesulfonate, and AA stands for sodium acrylate.

### INDUSTRIAL APPLICABILITY

The detergent composition of the present invention can be especially suitably used in hand-washing.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of improving smoothness during washing of an item to be washed, comprising the step of washing the item with a washing liquid under conditions where an organic polymer having spinnability is present in the washing liquid.

2. A method of improving smoothness during hand-washing of an item to be washed, comprising the step of hand-washing the item with a washing liquid under conditions where an organic polymer having spinnability is present in the washing liquid.

3. A process for hand-washing comprising the step of hand-washing an item to be washed with a washing liquid showing spinnability comprising an organic polymer having spinnability, or with a washing liquid prepared by diluting the washing liquid with more than 1-fold to 1,000-fold amount of water.

4. The process according to claim 3, wherein the washing liquid has a pH of 9.0 or more.

5. A detergent composition for improving smoothness, comprising an organic polymer having spinnability having an average molecular weight of 1,500,000 or more in an amount exceeding 0.1% by weight of the detergent composition.

6. The detergent composition according to claim 5, wherein the detergent composition comprises:
(a) an organic polymer having spinnability having an average molecular weight of 1,500,000 or more in an amount exceeding 0.1% by weight;
(b) a surfactant;
(c) an alkalizing agent; and
(d) a metal ion capturing agent.

7. The detergent composition according to claim 5, wherein the detergent composition comprises:
(a) a polyethylene oxide having spinnability having an average molecular weight of 1,500,000 or more in an amount exceeding 0.1% by weight;
(b-1) an anionic surfactant in an amount of 10% or more;
(c) an alkalizing agent; and
(d) a metal ion capturing agent,
wherein the detergent composition essentially consists of no polyoxyethylene alkyl ether (b-2).

8. The detergent composition according to any one of claims 5 to 7, wherein the detergent composition is in a powdery form or granular form.

9. The detergent composition according to any one of claims 5 to 8, further comprising an inorganic salt capable of releasing hydrogen peroxide in water, wherein the inorganic salt is contained in an amount of 15% by weight or less of the detergent composition.

10. A laundry detergent composition comprising a polymer having an average molecular weight of 500,000 or more, wherein 60% by mole or more of constituting monomers has a sulfonic acid group or a salt form thereof, or a sulfuric acid group or a salt form thereof.

11. The laundry detergent composition according to claim 10, wherein the laundry detergent composition is in a powdery form or granular form.

12. The laundry detergent composition according to claim 10 or 11, wherein the detergent composition comprises:
(a′) a polymer having an average molecular weight of 500,000 or more, wherein 60% by mole or more of constituting monomers has a sulfonic acid group or a salt form thereof, or sulfuric acid group or a salt form thereof;
(b) a surfactant;
(c) an alkalizing agent; and
(d) a metal ion capturing agent.

13. The laundry detergent composition according to any one of claims 10 to 12, wherein the constituting monomer is a unit derived from one or more monomers selected from the group consisting of 2-acrylamide-2-methylpropanesulfonic acid and a salt thereof, and styrenesulfonic acid and a salt thereof.

14. A creamy smoothness improver comprising an organic polymer having spinnability having an average molecular weight of 1,500,000 or more in an amount exceeding 0.1% by weight of the creamy smoothness improver.

15. The creamy smoothness improver according to claim 14, wherein the organic polymer is a polymer or copolymer made of a monomer selected from the group consisting of acrylic acid, acrylamide, acrylamide methylpropanesulfonic acid, dimethylaminoethyl methacrylic acid, vinyl alcohol, and mixtures thereof; a polysaccharide having a sugar backbone; or a polypeptide.

16. The creamy smoothness improver according to claim 14, wherein the organic polymer is a polyethylene oxide, and essentially consists of no polyoxyalkylene alkyl ether.

17. A creamy smoothness improver comprising a polymer having an average molecular weight of 500,000 or more, wherein 60% by mole or more of constituting monomers have a sulfonic acid group or a salt form thereof, or sulfuric acid group or a salt form thereof.

18. The creamy smoothness improver according to claim 17, wherein the constituting monomer is a unit derived from one or more monomers selected from the group consisting of 2-acrylamide-2-methylpropanesulfonic acid or a salt thereof, and styrenesulfonic acid or a salt thereof.

19. A process for washing an item to be washed with the laundry detergent composition as defined in claim 10.

20. A process for washing an item to be washed with the creamy smoothness improver as defined in claim 17.
